(19) United States
(12) Patent Application Publication
(10) Pub. No.: US 2008/0259178 A1
(43) Pub. Date: Oct. 23, 2008

(54) SOLID-STATE IMAGING DEVICE, SIGNAL PROCESSING METHOD FOR THE SAME, AND IMAGING APPARATUS

(75) Inventor: Yusuke Oike, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/107,248

(22) Filed: Apr. 22, 2008

(30) Foreign Application Priority Data
Apr. 23, 2007 (JP) 2007-112651

(51) Int. Cl. H04N 5/228; H04N 5/335; H04N 5/225

(52) U.S. Cl. 348/222.1; 348/294; 348/340; 348/E05.091; 348/E05.031; 348/E05.024

(57) ABSTRACT

Disclosed herein is a solid-state imaging device, including, a pixel array unit, driving means, and analog-to-digital conversion means.

### CROSS REFERENCES TO RELATED APPLICATIONS

The present invention contains subject matter related to Japanese Patent Application JP 2007-112651 filed in the Japan Patent Office on Apr. 23, 2007, the entire contents of which being incorporated herein by reference.

### BACKGROUND OF THE INVENTION

1. Field of the Invention

The present invention relates to a solid-state imaging device, a signal processing method for the same, and an imaging apparatus.

2. Description of the Related Art

FIG. 31 shows an example of a configuration of a unit pixel 100 of a solid-state imaging device. As with this example, in the unit pixel 100 having a transfer transistor for transferring signal charges obtained through photoelectric conversion in a photoelectric conversion element 101, a maximum quantity, Qfd·max, of charges accumulated which can be transferred to a floating diffusion capacitor (FD) 106 of the unit pixel is made sufficiently larger than a maximum quantity, Qpd·max, of charges accumulated in the photoelectric conversion element 101 as a light receiving unit. As a result, the perfect transfer of the signal charges from the photoelectric conversion element 101 to the floating diffusion capacitor 106 is realized by removing the residual charges in the photoelectric conversion element 101.

The perfect transfer is realized for the signal charges obtained through the photoelectric conversion in the photoelectric conversion element 101 in the manner as described above, which results in that a residual image in a phase of photographing of an image can be prevented and a satisfactory linearity between a luminance of an incident light and a sensor output signal can be realized. In this connection, the unit pixel 100 of this embodiment includes a reset transistor 103, an amplification transistor 104 and a pixel selecting transistor 105 in addition to the transfer transistor 102.

However, the unit pixel 100 shown in FIG. 31 involves the following problems.

(1) Since the maximum quantity, Qfd·max, of charges accumulated must be larger than the maximum quantity, Qpd·max, of charges accumulated in the photoelectric conversion element 101, there is a limit to reduction of the capacitance of the floating diffusion capacitor 106 for enhancement of a charge-to-voltage conversion efficiency.

(2) Since for the same reason as that of the above, a decrease in power source voltage Vdd used as a reset voltage for the floating diffusion capacitor 106 leads to reduction of the maximum quantity, Qfd·max, of charges accumulated in the floating diffusion capacitor 106, there is a limit to lowering of the power source voltage Vdd.

Then, heretofore, the problems (1) and (2) described above are solved in the following manner. That is to say, when the maximum quantity, Qfd·max, of charges accumulated is less due to the reduction of the capacitance of the floating diffusion capacitor 106 for enhancement of a charge-to-voltage conversion efficiency, or when the maximum quantity, Qfd·max, of charges accumulated is less owing to the lowering of the reset voltage (power source voltage) Vdd, after the charge transfer, the signal reading, and the reset of the floating diffusion capacitor 106 are carried out, the charges which remain in the photoelectric conversion element 101 because they are more than the transfer transistor 102 can transfer are transferred again to read out the signal. As a result, all the charges accumulated in the photoelectric conversion element 101 are read out in plural batches. This technique, for example, is described in the Japanese Patent Laid-Open No. 2001-177775.

### SUMMARY OF THE INVENTION

However, when as with the related art described above, the charges accumulated in the photoelectric conversion element 101 for an accumulation period of time through the photoelectric conversion are transferred on the partition transfer basis (partition transfer), and analog-to-digital conversion is then carried out for the analog signals corresponding to the charges thus transferred, the analog-to-digital conversion processing must be executed plural times depending on the number of partitions in the partition basis transfer. As a result, it becomes difficult to speed up the analog-to-digital conversion processing, and also the power consumption increases.

In the light of the foregoing, it is therefore desirable to provide a solid-state imaging device which is capable of speeding up analog-to-digital conversion processing, and reducing power consumption with a configuration for transferring all accumulated charges in plural batches when they can not be outputted in one reading-out operation, and outputting signal charges on a partition transfer basis, a signal processing method for the same, and an imaging apparatus.

In order to attain the desire described above, according to an embodiment of the present invention, there is provided a solid-state imaging device, including:

a pixel array unit constituted by arranging unit pixels in matrix, each of the unit pixels including a photoelectric conversion unit configured to convert an optical signal into signal charges, a transfer element configured to transfer the signal charges obtained through photoelectric conversion in the photoelectric conversion unit, and output means configured to output the signal charges transferred by the transfer element;

driving means configured to read out the signal charges accumulated in the photoelectric conversion unit for an accumulation period of time of one unit and transferred at least in two batches by the transfer element through the output section; and

analog-to-digital conversion means configured to perform analog-to-digital conversion for a plurality of output signals read out from the unit pixel in plural batches with different conversion precisions.

According to another embodiment of the present invention, there is provided a signal processing method for a solid-state imaging device including:

a pixel array unit constituted by arranging unit pixels in matrix, each of the unit pixels including a photoelectric conversion unit configured to convert an optical signal into signal charges, a transfer element configured to transfer the signal charges obtained through photoelectric conversion in the photoelectric conversion unit, and an output section configured to output the signal charges transferred by the transfer element; and

driving means configured to read out the signal charges accumulated in the photoelectric conversion unit for an accumulation period of time of one unit and transferred at least in two batches by the transfer element through the output section;

wherein the solid-state imaging device performs analog-to-digital conversion for a plurality of output signals read out from the unit pixel in plural batches with different conversion precisions.

According to yet another embodiment of the present invention, there is provided an imaging apparatus, including:

a solid-state imaging device constituted by arranging unit pixels in matrix, each of the unit pixels including a photoelectric conversion unit configured to convert an optical signal into signal charges, a transfer element configured to transfer the signal charges obtained through photoelectric conversion in the photoelectric conversion unit, and output means configured to output the signal charges transferred by the transfer element; and

an optical system for focusing an incident light onto an imaging area of the solid-state imaging device;

wherein the solid-state imaging device includes:

driving means configured to read out the signal charges accumulated in the photoelectric conversion unit for an accumulation period of time of one unit and transferred at least in two batches by the transfer element through the output means; and

analog-to-digital conversion means configured to perform analog-to-digital conversion for a plurality of output signals read out from the unit pixel in plural batches with different conversion precisions.

According to the present invention, when the accumulated charges which can not be read out in one reading-out operation are transferred on the partition transfer basis, the analog-to-digital conversion is performed for a plurality of output signals read out from the unit pixel on the partition transfer basis with the different conversion precisions. As a result, it is possible to realize the speed-up of the analog-to-digital conversion processing, and the reduction of the power consumption.

### BRIEF DESCRIPTION OF THE DRAWINGS

FIG. 1 is a system configuration diagram showing a CMOS image sensor according to a first embodiment of the present invention;

FIG. 2 is a circuit diagram showing an example of a circuit configuration of a unit pixel shown in FIG. 1;

FIG. 3 is a circuit diagram showing another example of the circuit configuration of the unit pixel shown in FIG. 1;

FIG. 4 is a circuit diagram showing still another example of the circuit configuration of the unit pixel shown in FIG. 1;

FIG. 5 is a timing chart showing a timing relationship between a reset pulse RST and a transfer pulse TRG when partition transfer is carried out on a quadri-partition basis;

FIG. 6 is an energy diagram explaining an operation when a luminance of an incident light is high in the quadri-partition transfer;

FIG. 7 is an energy diagram explaining an operation when the luminance of the incident light is low in the quadri-partition transfer;

FIG. 8 is a block diagram showing an example of a configuration of a signal processing circuit shown in FIG. 1;

FIG. 9 is a block diagram showing another example of the configuration of the signal processing circuit shown in FIG. 1;

FIG. 10 is a block diagram showing an example of a concrete configuration of an A/D conversion unit, having a noise removing function and an addition function, shown in FIG. 9;

FIG. 11 is a timing chart showing an operation timing of A/D conversion processing executed with the same conversion precision;

FIG. 12 is a timing chart showing an operation timing of A/D conversion processing executed with different conversion precisions;

FIG. 13 is a characteristic diagram showing a relationship between an intensity of an incident light and a noise level of a signal read out when a maximum quantity of charges accumulated is set as 10,000 electrons;

FIG. 14 is a system configuration diagram showing a CMOS image sensor according to a second embodiment of the present invention;

FIG. 15 is a block diagram showing an example of a configuration of a column circuit shown in FIG. 14;

FIG. 16 is a block diagram showing another example of the configuration of the column circuit shown in FIG. 14;

FIG. 17 is a system configuration diagram showing a CMOS image sensor according to a third embodiment of the present invention;

FIG. 18 is a circuit diagram showing an example of a circuit configuration of a supplied-voltage controlling circuit shown in FIG. 17;

FIG. 19 is a timing chart showing a timing relationship between an inputting operation and an outputting operation in the supplied-voltage controlling circuit;

FIG. 20 is a timing chart showing a driving timing example in the case of tri-partition transfer;

FIG. 21 is an energy diagram explaining an operation in the case of the tri-partition transfer;

FIG. 22 is a graph showing experimental results as an example of a relationship between a TRG driving voltage and the number of charges held in a photoelectric conversion element;

FIG. 23 is a timing chart showing a driving timing example in the case of n-partition transfer;

FIGS. 24A and 24B are respectively diagrams each showing a relationship between a maximum quantity, Qpd·max, of charges accumulated which a photoelectric conversion unit can treat, and maximum values Qfd·max in respective partition transfer operations;

FIG. 25 is a graph explaining processing when the A/D conversion is performed with different conversion precisions during tri-partition transfer;

FIG. 26 is a characteristic diagram showing a relationship between a signal level and a noise level each of which is proportional to a luminance of an incident light;

FIG. 27 is an explanatory diagram showing a concrete example in which different A/D conversion precisions are set;

FIG. 28 is a circuit diagram showing a pixel circuit of a unit pixel of Modification 1;

FIG. 29 is a circuit diagram showing a pixel circuit of a unit pixel of Modification 2;

FIG. 30 is a block diagram showing a configuration of an imaging apparatus according to an embodiment of the present invention; and

FIG. 31 is a circuit diagram showing an example of a configuration of a unit pixel in the related art.

### DETAILED DESCRIPTION OF THE PREFERRED EMBODIMENTS

Preferred embodiments of the present invention will be described in detail hereinafter with reference to the accompanying drawings.

### First Embodiment

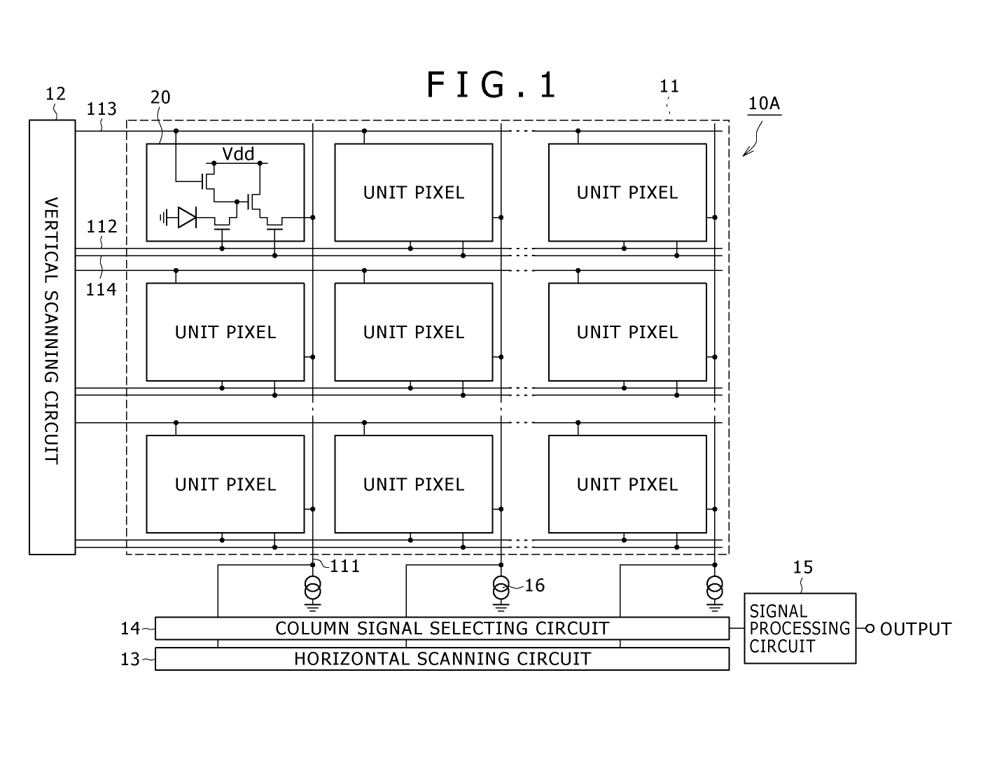

FIG. 1 is a system configuration diagram showing a configuration of a solid-state imaging device, for example, a CMOS image sensor according to a first embodiment of the present invention.

As shown in FIG. 1, a CMOS image sensor 10A of this embodiment includes a pixel array unit 11, and its peripheral circuit. In this case, the pixel array unit 11 is configured such that units pixels each including a photoelectric conversion element (hereinafter simply referred to as “a pixel” in some cases) 20 are two-dimensionally arranged in matrix. A vertical scanning circuit 12, a horizontal scanning circuit 13, a column signal selecting circuit 14, a signal processing circuit 15, and the like, for example, are provided as the peripheral circuit of the pixel array unit 11.

For the matrix arrangement of the pixels 20 in the pixel array unit 11, a vertical signal line 111 is wired every pixel column, and driving control lines, for example, a transfer control line 112, a reset control line 113, and a selection control line 114 are wired every pixel row.

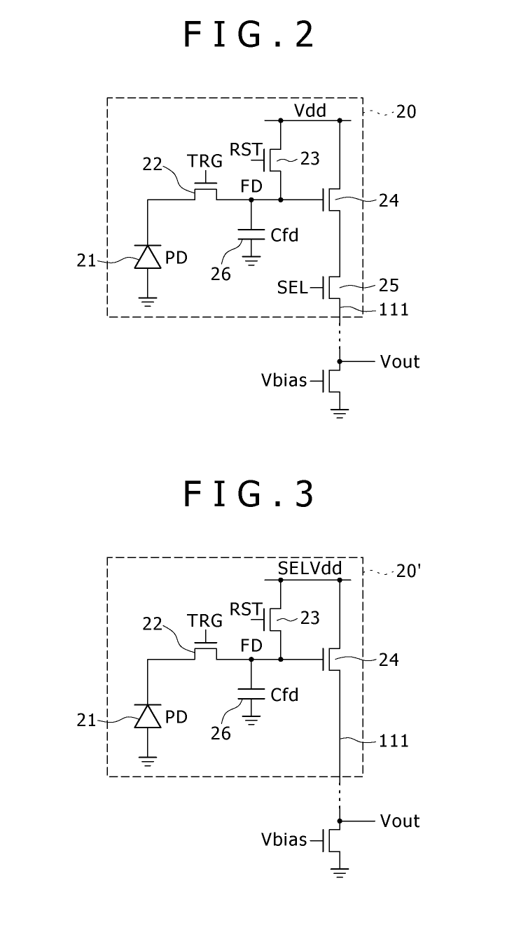

Constant current sources 16 are connected to one ends of the vertical signal lines 111, respectively. A transistor for current bias a gate of which, for example, is biased by a bias voltage Vbias may be used instead of using the constant current source 16. In this case, the transistor for current bias configures, together with an amplification transistor 24 which will be described later, a source follower circuit (refer to FIG. 2).

The vertical scanning circuit 12 is constituted by a shift register, an address decoder or the like. In addition, while vertically scanning the pixels 20 of the pixel array unit 11 in units of rows with respect to each of the electronic shutter rows and the read-out rows, the vertical scanning circuit 12 carries out an electronic shutter operation for sweeping off the signals from corresponding ones of the pixels 20 belonging to the electronic shutter row, and carries out a reading-out operation for reading out the signals from corresponding ones of the pixels belonging to the read-out row.

Although an illustration is omitted here, the vertical scanning circuit 12 includes a reading-out scanning system, and an electronic shutter scanning system. In this case, the reading-out scanning system carries out the reading-out operation for reading out the signals from the pixels 20 belonging to the read-out row while successively selecting the pixels 20 in units of the rows. Also, the electronic shutter scanning system carries out the electronic shutter operation for the same row (electronic shutter row) before the reading-out scanning by the reading-out scanning system by a period of time corresponding to a shutter speed.

Also, a period of time ranging from a first timing to a second timing becomes an accumulation period of time (exposure period of time) of one unit for the signal charges in each of the pixels 20. Here, at the first timing, the unnecessary charges in the photoelectric conversion unit are reset through the shutter scanning by the electronic shutter scanning system. Also, at the second timing, the signals are read out from the pixels, respectively, through the reading-out scanning by the reading-out scanning system. That is to say, the electronic shutter operation means an operation for resetting (sweeping off) the signal charges accumulated in the photoelectric conversion unit, and starting to newly accumulate the signal charges after completion of the reset of the signal charges.

The horizontal scanning circuit 13 is constituted by a shift register, an address decoder or the like. The horizontal scanning circuit 13 horizontally scans the pixel columns of the pixel array unit 11 in order. The column signal selecting circuit 14 is composed of a horizontal selecting switch, a horizontal signal line, and the like. The column signal selecting circuit 14 successively outputs the signals of the respective pixels 20 which are outputted from the pixel array unit 11 through the vertical signal lines 111 in correspondence to the pixel rows, respectively, synchronously with the horizontal scanning operation made by the horizontal scanning circuit 13.

The signal processing circuit 15 executes various signal processing such as noise removing processing, analog-to-digital (A/D) conversion processing, and addition processing for the signals of the pixel 20 which are outputted in units of pixels from the column signal selecting circuit 14. This embodiment features a configuration and an operation of the signal processing circuit 15. The details of the feature of this embodiment will be described later.

It is noted that a timing signal and a control signal each of which becomes a reference for operations of the vertical scanning circuit 12, the horizontal scanning circuit 13, the signal processing circuit 15, and the like are generated from a timing controlling circuit (not shown).

### (Pixel Circuit)

FIG. 2 is a circuit diagram showing an example of a circuit configuration of the unit pixel 20. The unit pixel 20 of this example is configured as a pixel circuit including four transistors, for example, a transfer transistor (transfer element) 22, a reset transistor 23, an amplification transistor 24, and a selection transistor 25 in addition to a photoelectric conversion element (photoelectric conversion unit) 21 such as a buried photodiode. In this case, although N-channel MOS transistors, for example, are used as the four transistors 22 to 25, the present invention is by no means limited to this configuration.

The transfer transistor 22 is connected between a cathode electrode of the photoelectric conversion element 21 and the floating diffusion capacitor (FD) 26. The transfer transistor 22 transfers signal charges (electrons in this case) which have been accumulated through the photoelectric conversion in the photoelectric conversion element 21 to the floating diffusion capacitor 26 by supplying a transfer pulse TRG to its gate electrode (control electrode). Thus, the floating diffusion capacitor 26 serves as a charge-to-voltage conversion unit for converting the signal charges into a voltage signal.

A drain electrode of the reset transistor 23 is connected to a pixel power source for supplying a power source voltage Vdd, and a source electrode thereof is connected to one end of the floating diffusion capacitor 26 opposite to a grounding end thereof. Prior to the transfer of the signal charges from the photoelectric conversion element 21 to the floating diffusion capacitor 26, the reset transistor 23 resets a potential of the floating diffusion capacitor 26 to a reset voltage Vrst in accordance with a reset pulse RST supplied to its gate electrode.

A gate electrode of the amplification transistor 24 is connected to the one end of the floating diffusion capacitor 26, and a drain electrode thereof is connected to the pixel power source for supplying the power source voltage Vdd. The amplification transistor 24 outputs the potential of the floating diffusion capacitor 26, after being reset by the reset transistor 23, in the form of a signal having a reset level, and outputs a potential of the floating diffusion capacitor 26, after the signal charges are transferred to the floating diffusion capacitor 26 by the transfer transistor 22, in the form of a signal having a signal level.

For example, a drain electrode of the selection transistor 25 is connected to a source electrode of the amplification transistor 24, and a source electrode thereof is connected to the vertical signal line 111. The selection transistor 25 is turned ON in accordance with a selection pulse SEL applied to its gate electrode to set the pixel 20 in a selection state, thereby outputting a signal outputted from the amplification transistor 24 to the vertical signal line 111. The selection transistor 25 can also adopt a configuration of being connected between the pixel power source (Vdd) and the drain electrode of the amplification transistor 24.

Note that, although the case where the embodiment of the present invention is applied to the CMOS image sensor including the unit pixel 20 having the four-transistor configuration including the transfer transistor 22, the reset transistor 23, the amplification transistor 24, and the selection transistor 25 has been given here as an example, the present invention is by no means limited to this application example.

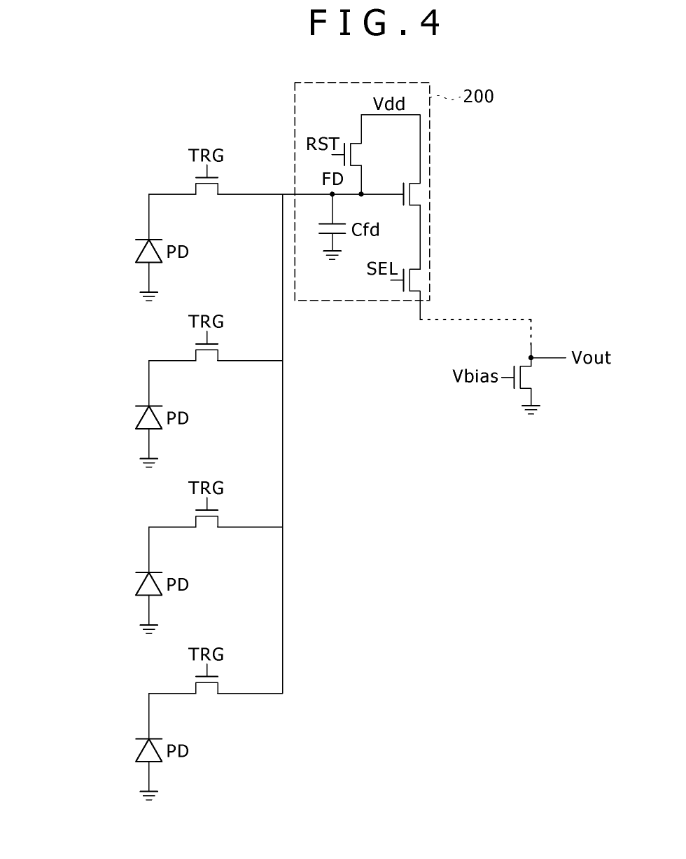

Specifically, the present invention can also be applied to a CMOS image sensor including a unit pixel 20′ having a three-transistor configuration in which as shown in FIG. 3, the selection transistor 25 shown in FIG. 2 is omitted, and a power source voltage SELVdd is made variable, thereby giving the amplification transistor 24 the function of the selection transistor 25, a CMOS image sensor having a configuration in which as shown in FIG. 4, a floating diffusion capacitor FD and a reading-out circuit 200 are shared among a plurality of pixels, or the like.

In the CMOS image sensor 10A having the configuration described above, the vertical scanning circuit 12 for driving the constituent elements (the transfer transistor 22, the reset transistor 23, and the selection transistor 25) of the unit pixel 20 constitutes a driving section. In this case, the signal charges accumulated in the photoelectric conversion element 21 for an accumulation period of time of one unit are partitioned at least in two batches by the transfer transistor 22. Thus, the driving section reads out the signal charges on the partition transfer basis to the vertical signal line 111 through an output section (composed of the reset transistor 23, the floating diffusion capacitor 26, the amplification transistor 24, and the selection transistor 25).

### (Partition Transfer)

The CMOS image sensor 10A having the configuration described above carries out an operation for transferring the signal charges accumulated in the photoelectric conversion element 21 for the accumulation period of time of one unit at least in two batches to the floating diffusion capacitor 26 (on the partition transfer basis), and reading out the voltage signals obtained through the photoelectric conversion in the photoelectric conversion element 21 to the vertical signal line 111 through the amplification transistor 24 in units of the pixel rows under the driving based on the transfer pulse TRG, the reset pulse RST and the selection pulse SEL which are suitably outputted from the vertical scanning circuit 12. Also, a plurality of voltage signals read out from the unit pixel 20 on the partition transfer basis are subjected to the addition processing in the signal processing circuit 15 in a subsequent stage.

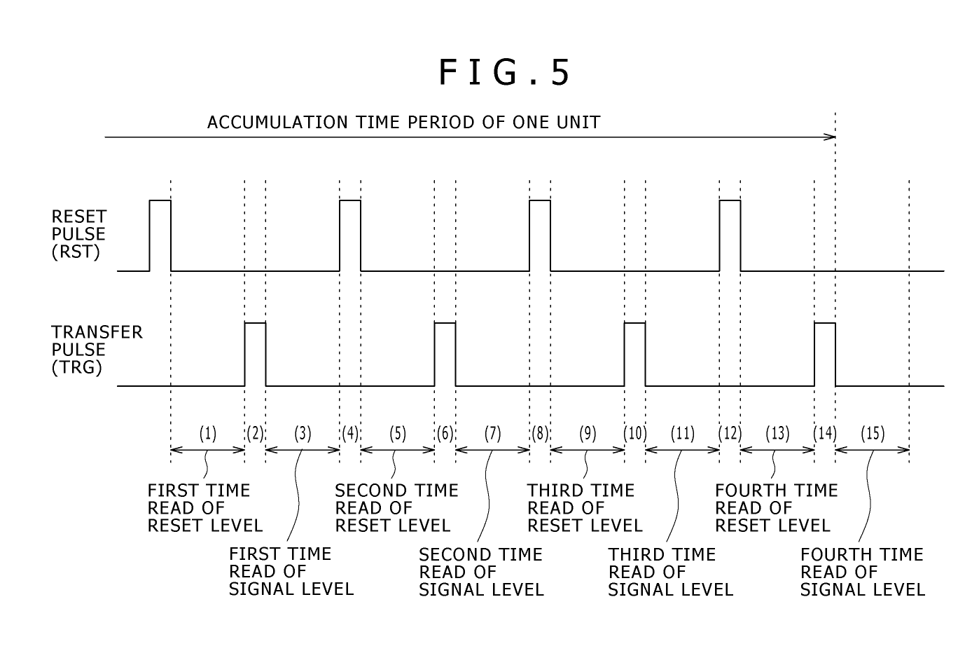

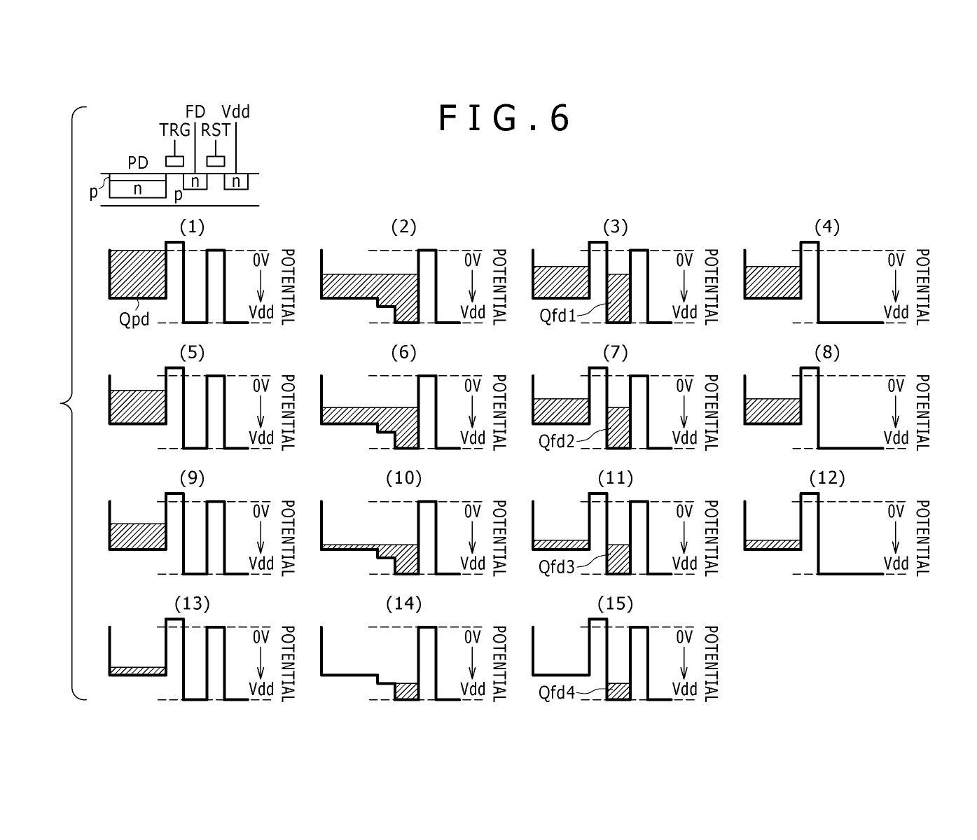

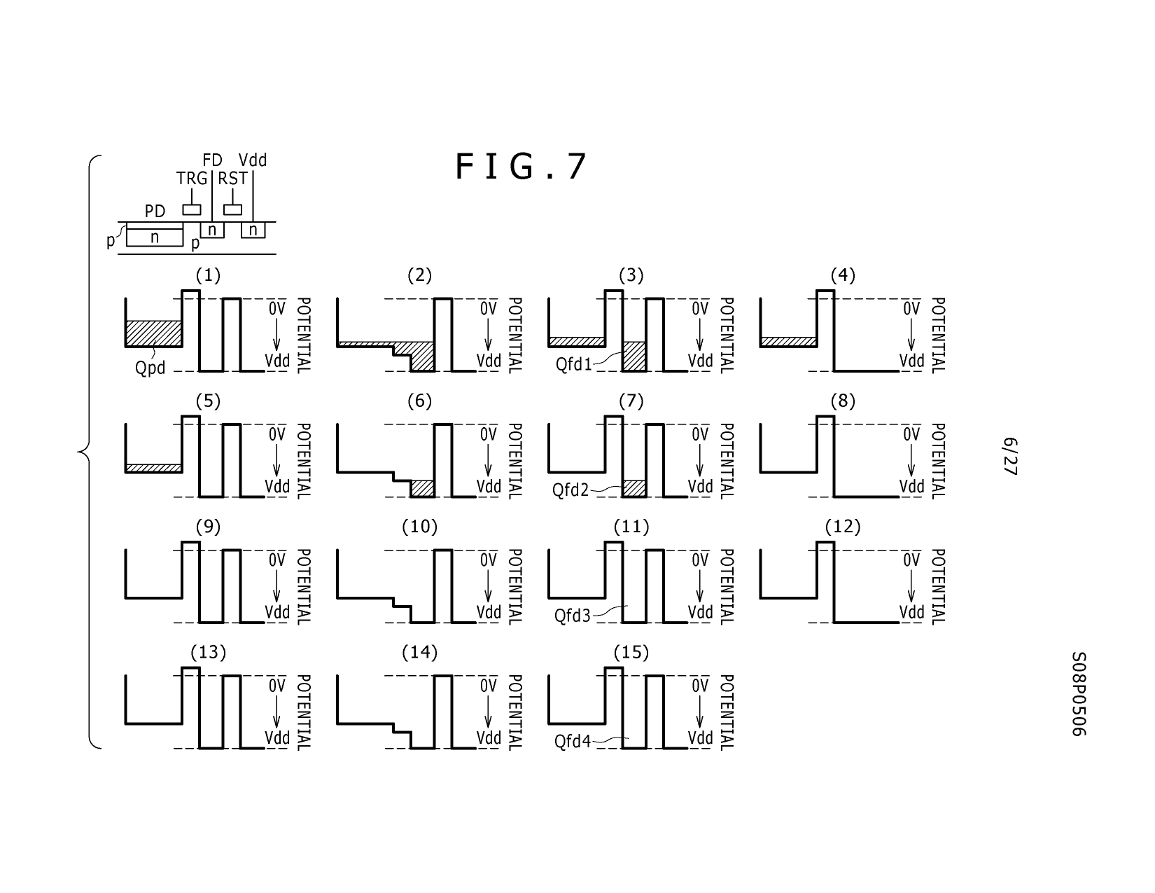

Here, FIG. 5 shows a timing relationship between the reset pulse RST and the transfer pulse TRG when the partition transfer is carried out on a quadri-partition transfer basis as an example. In addition, FIG. 6 shows an energy diagram explaining operations when a luminance of an incident light is high, and FIG. 7 shows an energy diagram explaining operations when the luminance of the incident light is low. In FIGS. 6 and 7, operations (1) to (15) correspond to periods (1) to (15) of time shown in FIG. 5, respectively.

When the signal charges are transferred in four batches, and the charges having the quantity Qfd1, Qfd2, Qfd3, and Qfd4 which are read out in the respective charge transferring operations are added to one another to obtain the accumulated charges having the quantity Qpd (=Qfd1+Qfd2+Qfd3+Qfd4). In addition, in the pixel in which the luminance of the incident light is high and the photoelectric conversion element 21 accumulates therein a large quantity of charges, as shown in FIG. 6, all the accumulated charges having the quantity Qpd can be read out because the quadri-partition and the addition are carried out.

### (Signal Processing Circuit)

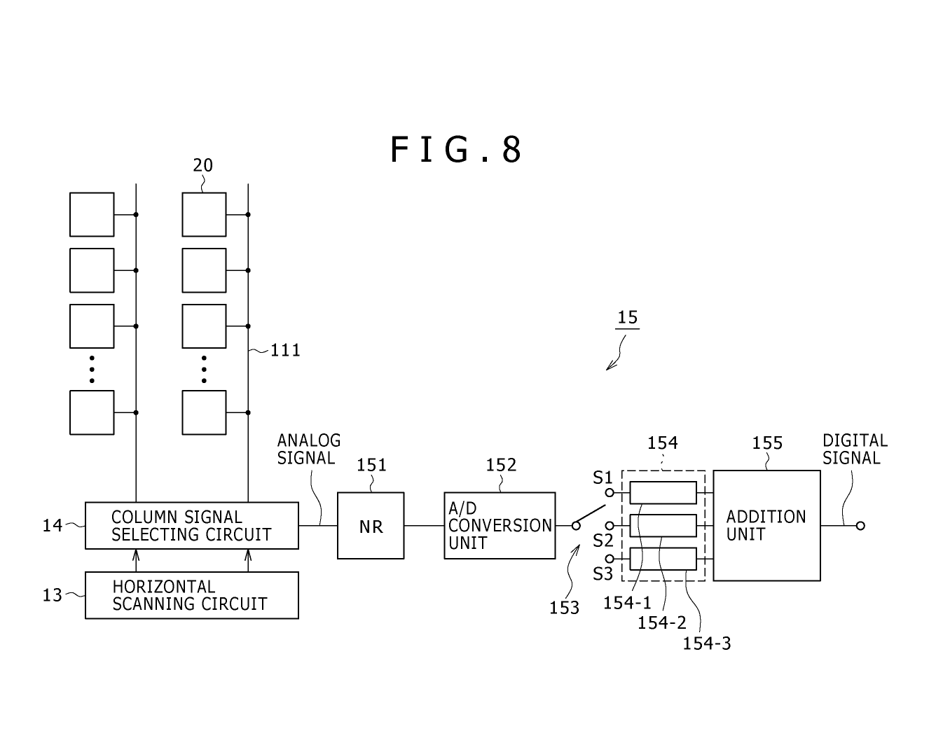

FIG. 8 is a block diagram showing an example of a configuration of the signal processing circuit 15 shown in FIG. 1. In this case, the case where the number, n, of partitions in the partition basis transfer, for example, is set as 3 (n=3) is given as an example.

As shown in FIG. 8, the signal processing circuit 15 of this example includes a noise removing unit 151, an A/D conversion unit 152, a signal selecting unit 153, a signal holding unit 154, and an addition unit 155.

The noise removing unit 151, for example, includes a correlated double sampling (CDS) circuit. The noise removing unit 151 successively obtains differences between reset levels and signal levels respective signals of which are successively supplied from the unit pixels 20, thereby removing the reset noises and the fixed pattern noises inherent in each of the pixels owing to a dispersion in threshold of the amplification transistor 24, or the like. The A/D conversion unit 152 converts the analog output signal thus supplied thereto into a digital signal through A/D conversion.

The signal selecting unit 153 successively selects one of the digital signals which are outputted from the A/D conversion unit 152 in order in correspondence to the first time, second time and third time partition basis transfers, and instructs the signal holding unit 154 to hold the digital signals thus selected in order in its holding units 154-1, 154-2 and 154-3, respectively. The addition unit 155 adds the first time, second time and third time output signals held in the holding units 154-1, 154-2 and 154-3, respectively, to one another.

In the signal processing circuit 15 having the configuration described above, the noise removing unit 151, the A/D conversion unit 152, the signal selecting unit 153, the signal holding unit 154, and the addition unit 155, for example, are integrated with one another on the same semiconductor substrate as that of the pixel array unit 11.

However, there is no necessity for integrating all the noise removing unit 151, the A/D conversion unit 152, the signal selecting unit 153, the signal holding unit 154, and the addition unit 155 with one another on the same semiconductor substrate as that of the pixel array unit 11. That is to say, ones of or all of them may be integrated with one another on another semiconductor substrate.

Note that, in the above case, the example has been shown in which the noise removing unit 151 is disposed on a side of a preceding stage of the A/D conversion unit 152. However, the noise removing unit 151 may be disposed on a side of a subsequent stage of the A/D conversion unit 152, so that the A/D conversion is carried out in the digital processing. Or, the A/D conversion unit 152 may be given a noise removing function, so that the noise removal is carried out while the A/D conversion is carried out.

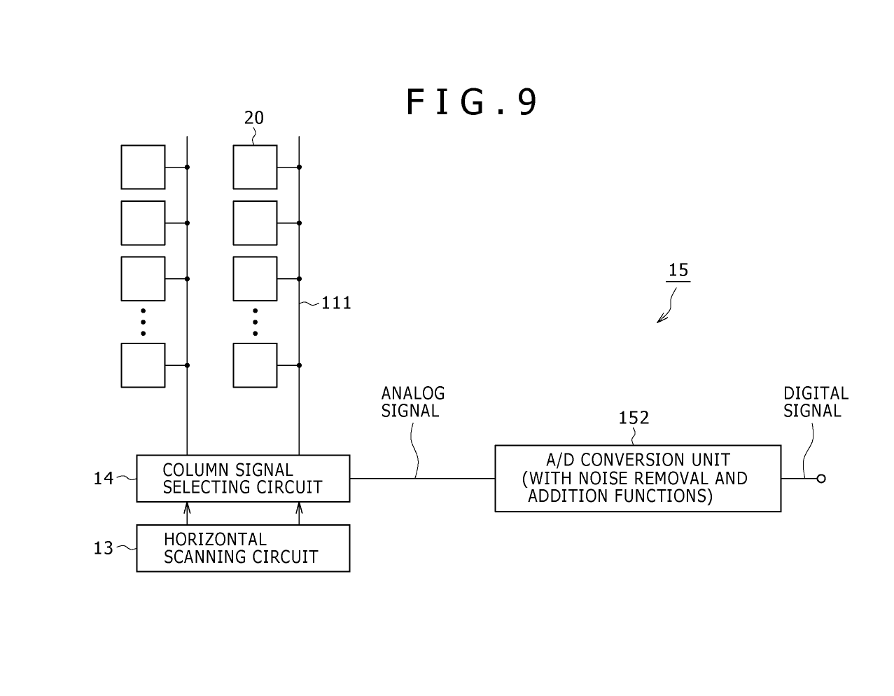

In addition, as shown in FIG. 9, the A/D conversion unit 152 having a noise removing function and an addition function may constitute the signal processing circuit 15, so that the noise removing processing and the addition processing are executed in parallel with the A/D conversion processing.

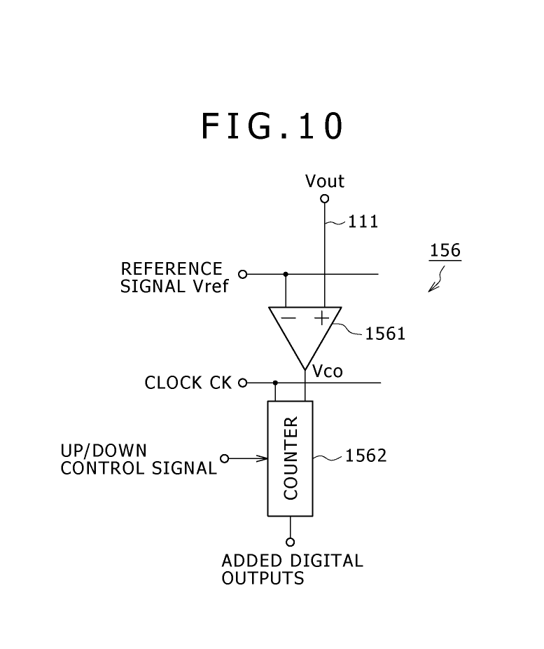

FIG. 10 is a block diagram showing an example of a concrete configuration of the A/D conversion unit 156 having the noise removing function and the addition function. In addition, the A/D conversion unit 156 of this example includes a voltage comparator 1561 and a counter 1562.

The voltage comparator 1561 receives a reference signal Vref having a ramp waveform at its inverting (−) input terminal, and receives an output signal Vout supplied from the unit pixel 20 through the vertical signal line 111 at its non-inverting (+) terminal. When the output signal Vout is higher in level than the reference signal Vref, the voltage comparator 1561 outputs a comparison result Vco.

The counter 1562 is constituted by an up/down counter. The counter 1562 carries out a count operation for up-count/down-count synchronously with a clock CK under the control based on an up/down control signal for a period of time required for the comparison result Vco in the voltage comparator 1561 to change, thereby incrementing or decrementing a count value.

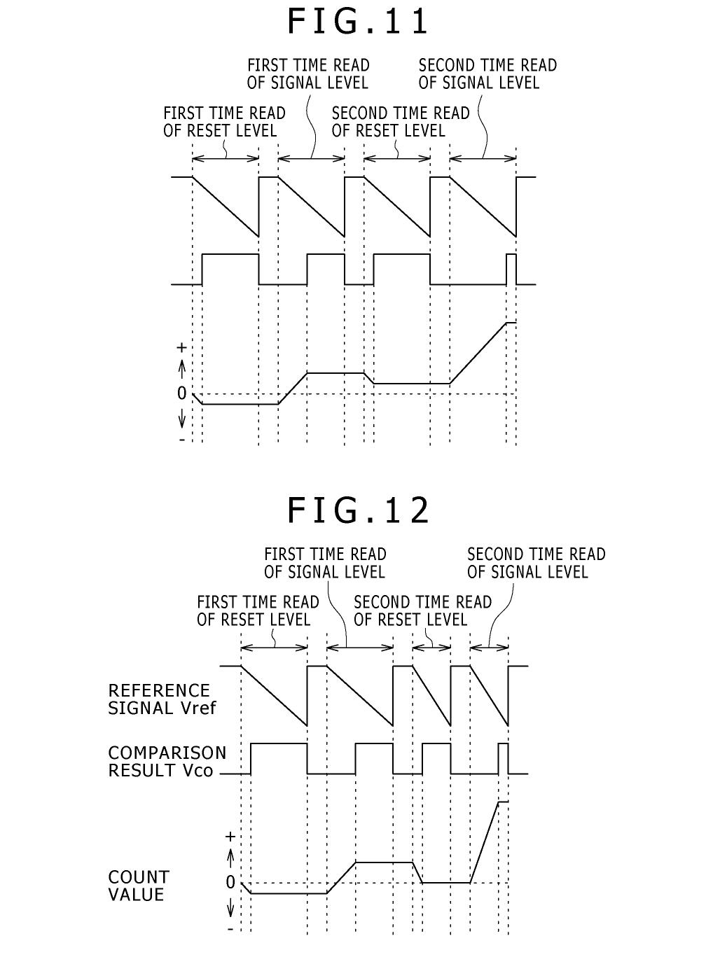

FIG. 11 shows waveforms of the reference signal Vref having the ramp waveform, and the comparison result Vco obtained from the voltage comparator 1561, and a count value in the counter 1562.

In this example, for the output signals obtained based on the tri-partition transfer, the count value in the counter 1562 is decremented in the first time reading-out operation for reading out the signal having the reset level, and the count value in the counter 1562 is then decremented in the first time reading-out operation for reading out the signal having the signal level. As a result, a count value corresponding to a difference between the reset level and the signal level is obtained (noise removing processing).

In such a manner, the noise removing processing is executed concurrently with the A/D conversion processing. In addition, the count value in the counter 1562 is decremented in the second time reading-out operation for reading out the signal having the reset level, and the count value in the counter 1562 is decremented in the second time reading-out operation for reading out the signal having the signal level so as to follow the first time A/D conversion processing. As a result, the result after completion of the second time removing processing can be added to the result after completion of the first time removing processing (addition processing).

That is to say, for the output signals obtained based on the tri-partition transfer, the operation for obtaining the count value corresponding to the difference between the reset level and the signal level is repeatedly carried out, so that the count value in the counter 1562 is repeatedly incremented or decremented. As a result, it is possible to obtain the digital output signal which is obtained by adding the differences between the reset levels and the signal levels in the reading-out operations based on the respective partition transfers.

As apparent from the above, the A/D conversion unit 156 can be given the functions of the signal holding unit 153 and the addition unit 155.

The signal processing circuit 15 includes the A/D conversion unit 156 having the noise removing function and the addition function in the manner as described above, which results in that the noise removing unit 151, and the holding units 153-1, 153-2 and 153-3 of the signal holding unit 153 become unnecessary, and it is also unnecessary to increase the number of holding units 153-1, 153-2 and 153-3 in correspondence to the number, n, of partitions for the partition basis transfer. As a result, it is possible to simplify the circuit configuration of the signal processing circuit 15.

### <Problem in A/D Conversion>

Here, when the A/D conversion is carried out for the output signals read out from the unit pixel 20 with the same conversion precision in all the reading-out operations based on the n-partition transfer as shown in FIG. 11, each of the execution time for the A/D conversion, and the power consumption increases in proportion to the number, n, of partitions.

<A/D Conversion with Different Conversion Precisions>

In order to cope with such a situation, in the CMOS image sensor of this embodiment, as shown in FIG. 12, the A/D conversion is carried out with the different conversion precisions for the first time and second time reading-out operations. Specifically, a ramp of the reference signal Vref in the second time reading-out operation is made larger than that of the reference signal Vref in the first time reading-out operation to increase a minimum quantity of detection in the A/D conversion, that is, a quantity of signals per one count, thereby reducing the conversion precision in the second time A/D conversion.

The A/D conversion unit 156 of this example adopts the configuration for performing the addition processing as well concurrently with the A/D conversion. For this reason, for the addition processing executed with the same weighting factor, when the ramp of the reference signal Vref in the second time reading-out operation is N times as large as that of the reference signal Vref in the first time reading-out operation, the second time counting operation is performed with its count number per one clock being made N times as large as that in the first time counting operation, thereby causing the conversion precision in the second time counting operation to be 1/N times as small as that in the first time counting operation.

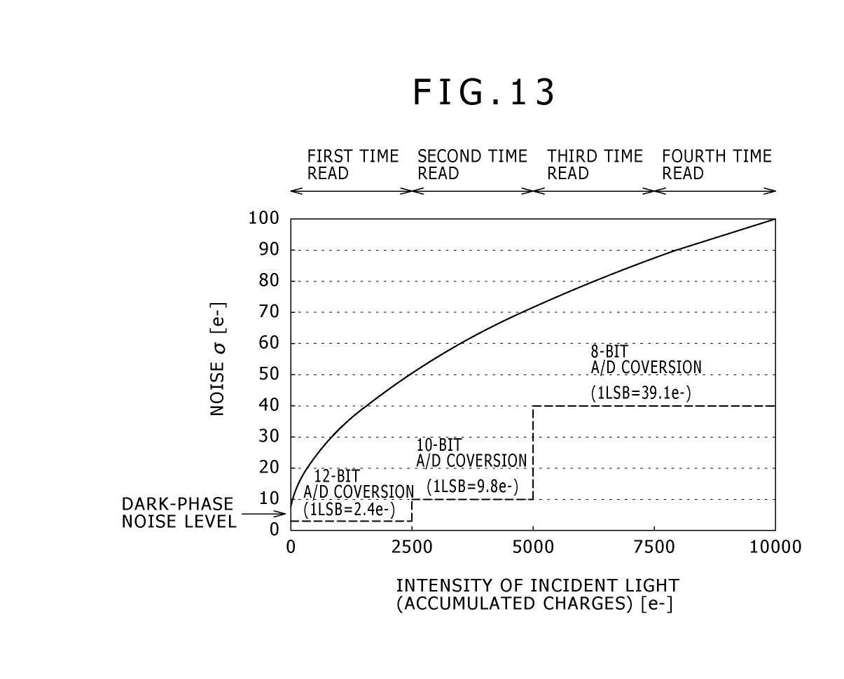

FIG. 13 is a characteristic diagram showing a relationship between an intensity of an incident light (accumulated charges) and a noise level of a signal read out when the maximum quantity of charges accumulated in the photoelectric conversion element 21 is set as 10,000 electrons. In this case, the fixed pattern noise in the reading-out operation corresponds to 2 e⁻, the random noise in the reading-out operation corresponds to 7 e⁻, and the optical shot noise corresponding to the accumulated charges is contained as the noise component.

As shown in FIG. 13, a dark-phase noise level is dominant in a low luminance region having the less accumulated charges. However, when the intensity of the incident light increases, and the quantity of charges accumulated increases accordingly, the optical shot noise becomes dominant. For this reason, the application of the A/D conversion having the high conversion precision set therein to the low luminance results in that even in the case of the application of the A/D conversion having the low conversion precision set therein to the high luminance, for example, as shown in FIG. 13, the image quality is hardly deteriorated because no quantization error in the A/D conversion becomes dominant.

In this example, the conversion precisions per 1 LSB in the A/D conversion for 12 bits, 10 bits and 8 bits become 2.4 e⁻, 9.8 e⁻ and 39.1 e⁻, respectively. Thus, when the accumulated charges are transferred on a quadri-partition basis, the application of the conversion precisions as shown in FIG. 13 to the respective quadri-partition transferring operations based on the quadri-partition results in that the quantization error depending on the number of electrons corresponding to 1 LSB is largely smaller than the noise component such as the optical shot noise. As a result, this hardly exerts a bad influence on the image quality.

In the case of the A/D conversion unit 156 exemplified in FIG. 10, since the number of gradations depending on the conversion precision, and the execution time are proportional to each other, application of the conversion precision shown in FIG. 13 to the A/D conversion results in that 12-bit A/D conversion is carried out 4 times (4,096 gradations×4). On the other hand, when the A/D conversion is carried out with 12 bits (4,096 gradations), 10 bits (1,024 gradations), and 8 bits (256 gradations), the A/D conversion is carried out at a high speed which is 2.6 times as high as that in the above A/D conversion. In addition thereto, the power consumed in the counter 1562 can also be reduced to about 1/2.6 of that in the above case because the number of changes in the counter 1562 is proportional to the number of gradations.

(Effect of this Embodiment)

As has been described so far, in the CMOS image sensor 10A which performs the charge transfer and the signal output on the partition basis when all the accumulated charges in the photoelectric conversion element 21 can not be read out in one reading-out operation, the output signals outputted from the unit pixel 20 on the n-partition basis transfer are subjected to the A/D conversion with the different conversion precisions to be added to one another. As a result, the execution time (conversion speed) for the A/D conversion can be shortened without impairing the image quality, and the power consumed in each of the A/D conversion units 152 and 156 can be reduced.

More specifically, using the driving method based on the partition transfer described with reference to FIGS. 5 to 7 in the CMOS image sensor of this embodiment results in that when the quantity of charges accumulated in the photoelectric conversion element 21 is less, all the accumulated charges can be read out in the first partition basis transferring operation. Thus, as put down therewith in FIG. 13, the conversion precision of the A/D conversion is gradually reduced in correspondence to the reading-out order, thereby realizing the speed-up of the A/D conversion, and the reduction of the power consumption.

### Second Embodiment

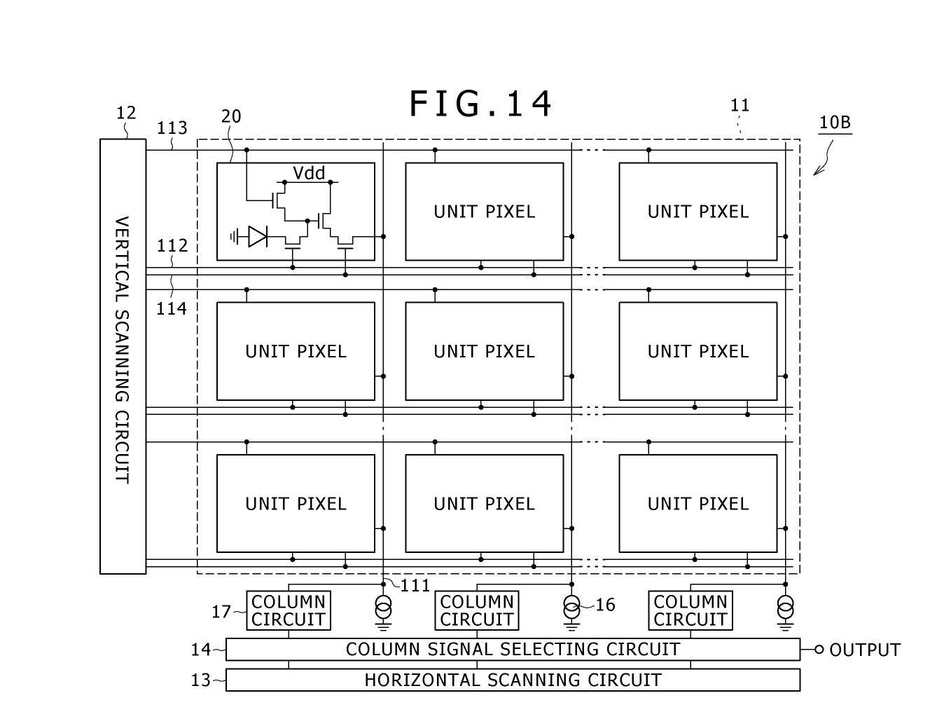

FIG. 14 is a system configuration diagram showing a configuration of a solid-state imaging device, for example, a CMOS image sensor according to a second embodiment of the present invention. In the figure, units equal to those previously described with reference to FIG. 1 are designated by the same reference numerals, respectively.

As shown in FIG. 14, a CMOS image sensor 10B of this embodiment includes a plurality of column circuits 17 which are arranged so as to correspond to the pixel columns of the pixel array unit 11, respectively, in addition to the pixel array unit 11, the vertical scanning circuit 12, the horizontal scanning circuit 13, and the column signal selecting circuit 14 are included. Any other suitable configuration other than the above configuration is basically the same as that of the CMOS image sensor 10A of the first embodiment.

A plurality of column circuits 17 execute the various signal processing such as the noise removing processing, the A/D conversion processing and the addition processing for the signals of the pixels 20 which are outputted in units of pixels from the pixel array unit 11 through the vertical signal lines 111, respectively. This embodiment features the configuration and the operation of each of the column circuits 17.

The CMOS image sensor 10B of this embodiment also uses the driving method based on the partition transfer described with reference to FIGS. 5 to 7. In the case of using that driving method, all the accumulated charges are read out in first one partition basis transferring operation or several partition basis transferring operations. As a result, when the quantity of charges accumulated is less, all the accumulated charges are read out in the first partition basis transferring operation.

### (Column Circuit)

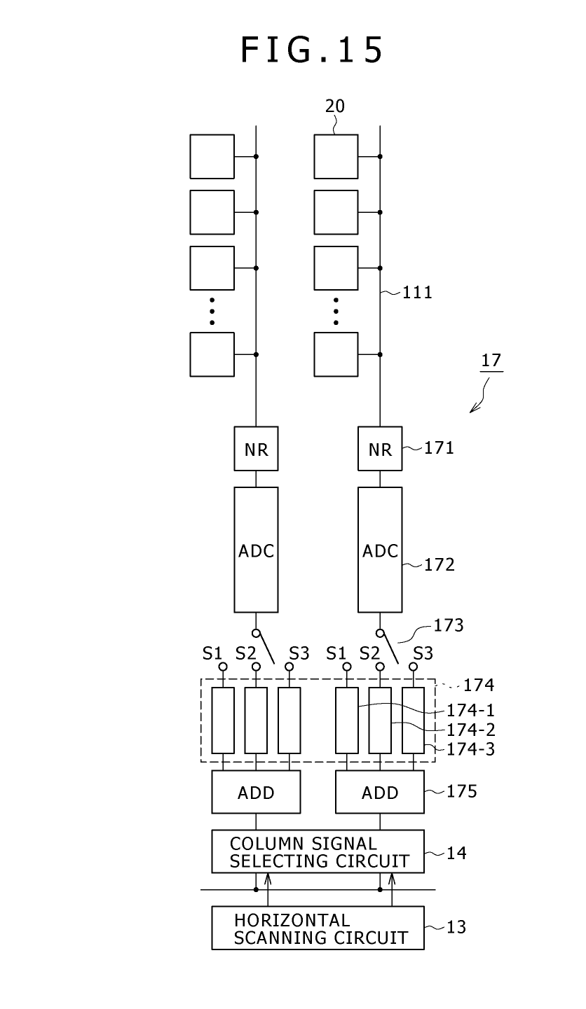

FIG. 15 is a block diagram showing an example of a configuration of the column circuit 17. In this case, the case where the number, n, of partitions for the partition basis transfer, for example, is set as 3 (n=3) is given as an example.

As shown in FIG. 15, the column circuit 17 of this example includes a noise removing unit 171, an A/D conversion unit 172, a signal selecting unit 173, a signal holding unit 174, and an addition unit 175. Thus, the column circuit 17 has basically the same configuration as that of the signal processing circuit shown in FIG. 8.

The noise removing unit 171, for example, is constituted by the CDS circuit. The noise removing unit 171 successively obtains differences between reset levels and signal levels respective signals of which are successively supplied from the unit pixels 20, thereby removing the reset noises and the fixed pattern noises inherent in each of the pixels owing to a dispersion in threshold of the amplification transistor 24, or the like. The A/D conversion unit 172 converts the analog output signal thus supplied thereto into a digital signal through A/D conversion.

The signal selecting unit 173 successively selects ones of the digital signals which are outputted from the A/D conversion unit 172 in order in correspondence to the first time, second time and third time partition transferring operations, and instructs the signal holding unit 174 to hold the digital signals thus selected in order in its holding units 174-1, 174-2 and 174-3, respectively. The addition unit 175 adds the first time, second time and third time output signals held in the holding units 174-1, 174-2 and 174-3, respectively, to one another.

Note that, in the above case, the example has been shown in which the noise removing unit 171 is disposed on a side of a preceding stage of the A/D conversion unit 172. However, the noise removing unit 171 may be disposed on a side of a subsequent stage of the A/D conversion unit 172, so that the A/D conversion is carried out in the digital processing. Or, the A/D conversion unit 172 may be given a noise removing function, so that the noise removal is carried out while the A/D conversion is carried out.

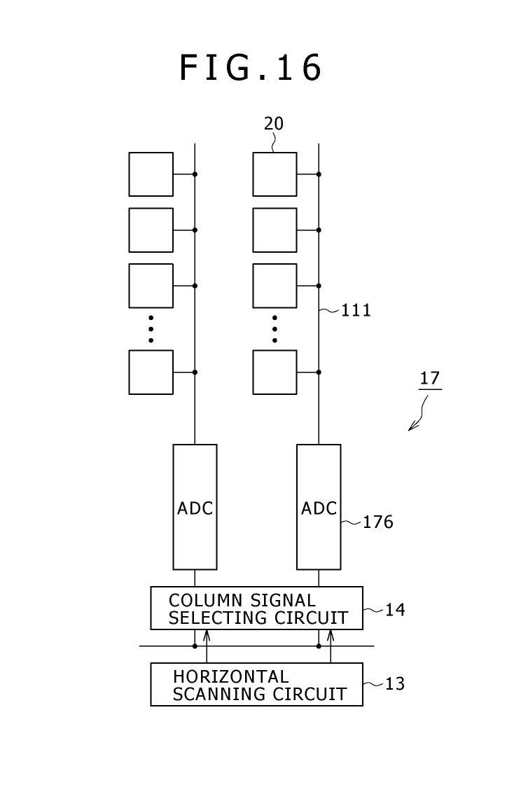

In addition, as shown in FIG. 16, the A/D conversion unit 176 having a noise removing function and an addition function may constitute the signal processing circuit 15, so that the noise removing processing and the addition processing are executed in parallel with the A/D conversion processing. The A/D conversion unit 176 having the noise removing function and the addition function may adopt the circuit configuration shown in FIG. 10.

In order to solve the problem described above in the case where the A/D conversion is carried out with the same conversion precision, the feature of the column circuit 17 having the above configuration is that the A/D conversion is carried out with the different conversion precisions for the first time and second time reading-out operations similarly to the case of the first embodiment (refer to FIG. 12). Specifically, a ramp of the reference signal Vref in the second time reading-out operation is made larger than that of the reference signal Vref in the first time reading-out operation to increase a minimum quantity of detection in the A/D conversion, that is, a quantity of signals per one count, thereby reducing the conversion precision in the second time A/D conversion.

(Effect of this Embodiment)

As has been described so far, in the CMOS image sensor 10B which performs the charge transfer and the signal output on the partition basis when all the accumulated charges in the photoelectric conversion element 21 can not be read out in one reading-out operation, the output signals outputted from the unit pixel 20 on the n-partition transfer are subjected to the A/D conversion with the different conversion precisions to be added to one another. As a result, the speed-up of the A/D conversion, and the reduction of the power consumption can be realized without impairing the image quality similarly to the case of the first embodiment.

### Third Embodiment

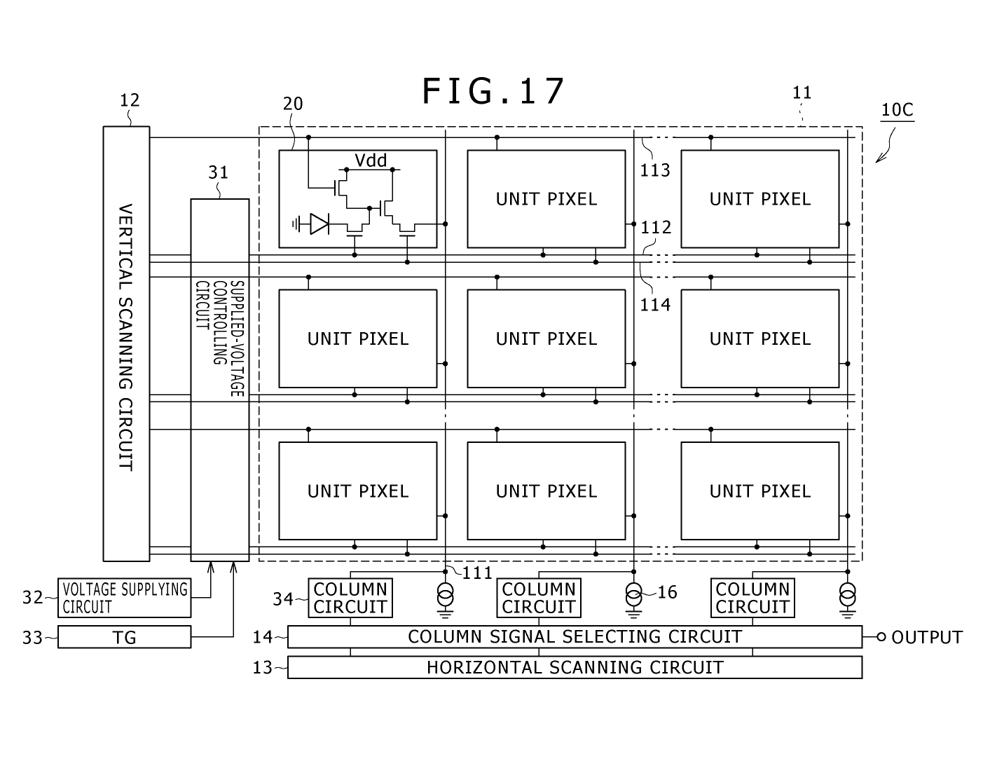

FIG. 17 is a system configuration diagram showing a configuration of a solid-state imaging device, for example, a CMOS image sensor according to a third embodiment of the present invention. In the figure, units equal to those previously described with reference to FIG. 1 are designated by the same reference numerals, respectively.

As shown in FIG. 17, the CMOS image sensor 10C of this embodiment includes a supplied-voltage controlling circuit 31, a voltage supplying circuit 32 and a timing generating circuit (TG) 33 in addition to the pixel array unit 11, the vertical scanning circuit 12, the horizontal scanning circuit 13, and the column signal selecting circuit 14. Also, the CMOS image sensor 10C includes a plurality of column circuits 34 which are arranged so as to correspond to the pixel columns of the pixel array unit 11, respectively. Any other suitable configuration other than the above configuration is basically the same as that of the CMOS image sensor 10B of the second embodiment.

A plurality of column circuits 17 execute the various signal processing such as the noise removing processing, the A/D conversion processing and the addition processing for the signals of the pixels 20 which are outputted in units of pixels from the pixel array unit 11 through the vertical signal lines 111, respectively. This embodiment features the configuration and the operation of each of the column circuits 17. The details of the feature of this embodiment will be described later.

The supplied-voltage controlling circuit 31 controls a voltage value (peak value) of a transfer pulse TRG applied to the gate electrode (control electrode) of the transfer transistor (transfer element) 22 within the unit pixel 20. A concrete configuration of this supplied-voltage controlling circuit 31 will be described later.

The voltage supplying circuit 32 supplies a plurality of control voltages having different voltage values to the supplied-voltage controlling circuit 31. The plurality of control voltages are supplied as the transfer pulses TRG having the different voltage values to the gate electrode of the transfer transistor 22. The details of the transfer pulses TRG having the different voltage values will be described later.

The timing generating circuit (TG) 33 generates a timing signal PTRG in accordance with which a timing is determined when the voltage supplying circuit 32 supplies a plurality of transfer pulses TRG having the different voltage values to the gate electrode of the transfer transistor 22.

The column circuit 34 executes the various signal processing such as the noise removing processing, the A/D conversion processing, and the addition processing for the signals of the pixels 20 which are outputted in units of the pixels from the pixel array unit 11 through the vertical signal line 111. A concrete configuration and an operation of the column circuit 34 will be described later.

### (Supplied-Voltage Controlling Circuit)

The supplied-voltage controlling circuit 31 receives as its input an address signal ADR in accordance with which the unit pixels 20 belonging to the row selected through the vertical scanning operation by the vertical scanning circuit 12 are driven to select one of a plurality of voltages supplied from the voltage supplying circuit 32, thereby supplying the voltage thus selected as the transfer pulse TRG to the gate electrode of the transfer transistor 22 within the unit pixel 20.

An ON voltage Von by which the transfer transistor 22 is turned ON, an OFF voltage Voff by which the transfer transistor 22 is turned OFF, and an intermediate voltage Vmid between the ON voltage and the OFF voltage are supplied as a plurality of voltages from the voltage supplying circuit 32. Here, the intermediate voltage Vmid means a voltage by which while a part of the accumulated charges in the photoelectric conversion element 21 is held, the remaining accumulated charges can be partially transferred to the floating diffusion capacitor 26.

In the pixel circuit described above, since the transfer transistor 22 is of the N-channel, the ON voltage is set as the power source voltage Vdd, and the OFF voltage Voff is set as the grounding voltage, preferably, set as a voltage lower than the grounding voltage. In addition, in this embodiment, two intermediate voltages Vmid0 and Vmid1 having different voltage values are used as the intermediate voltage Vmid.

As a result, the four voltages, that is, the ON voltage Von, the intermediate voltages Vmid0 and Vmid1, and the OFF voltage Voff are supplied from the voltage supplying circuit 32 to the supplied-voltage controlling circuit 31. The four voltages show a relationship of Voff<Vmid0<Vmid1<Von. Also, each of the intermediate voltages Vmid0 and Vmid1, and the ON voltage Von of the four voltages is used as the transfer pulse TRG.

In order to control timings at which the intermediate voltages Vmid0 and Vmid1, and the ON voltage Von are supplied from the voltage supplying circuit 32, respectively, three timing signals PTRG1, PTRG2 and PTRG3 are supplied from the timing generating circuit 33 to the supplied-voltage controlling circuit 31. The supplied-voltage controlling circuit 31 selects one of the intermediate voltages Vmid0 and Vmid1, and the ON voltage Von based on the timing signals PTRG1, PTRG2 and PTRG3, and supplies the selected one as the intermediate voltage Vmid to the gate electrode of the transfer transistor 22.

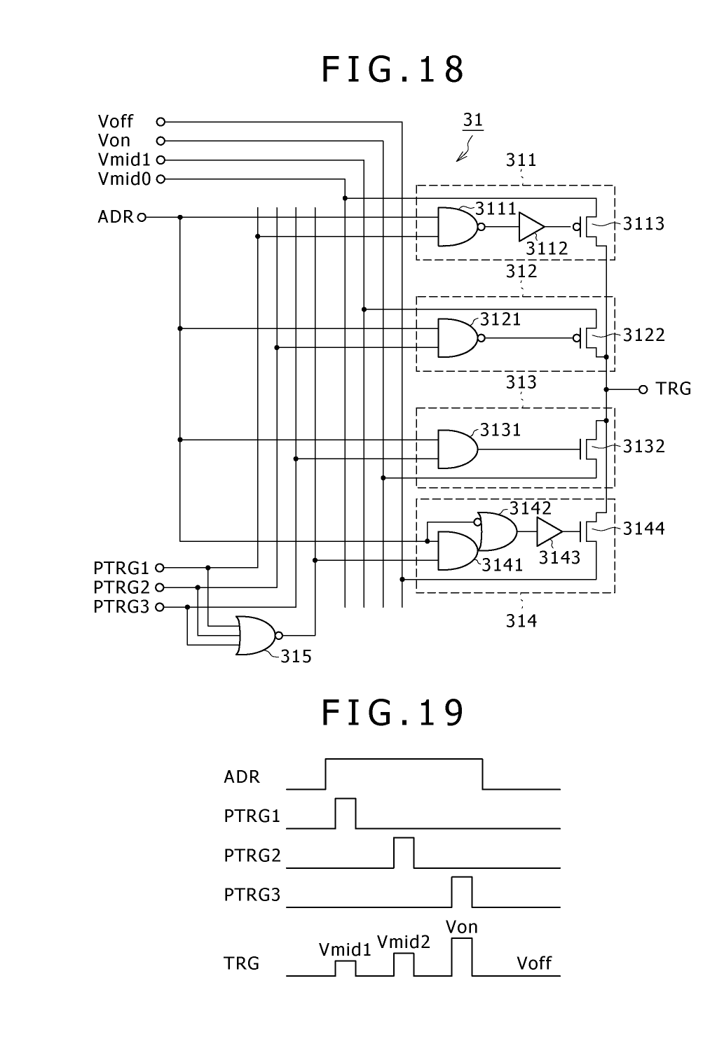

FIG. 18 is a circuit diagram showing an example of a circuit configuration of the supplied-voltage controlling circuit 31. As shown in FIG. 18, the supplied-voltage controlling circuit 31 includes four circuit blocks 311 to 314 corresponding to the four voltages, that is, the intermediate voltages Vmid0 and Vmid1, the ON voltage Von, and the OFF voltage Voff, respectively, and 3-input NOR circuit 315.

An address signal ADR is commonly supplied from the vertical scanning circuit 12 to each of the circuit blocks 311 to 314. The timing signals PTRG1, PTRG2 and PTRG3 are supplied as three inputs from the timing generating circuit 33 to the NOR circuit 315.

The circuit block 311 includes a NAND circuit 3111 for receiving its two inputs the address signal ADR and the timing signal PTRG1, a level shifter 3112, and a P-channel driving transistor 3113. The circuit block 311 selects the intermediate voltage Vmid0 and supplies the intermediate voltage Vmid0 thus selected to the gate electrode of the transfer transistor 22.

The circuit block 312 includes an NAND circuit 3121 for receiving as its two inputs the address signal ADR and the timing signal PTRG2, and a P-channel driving transistor 3122. The circuit block 312 selects the intermediate voltage Vmid1, and supplies the intermediate voltage Vmid1 thus selected to the gate electrode of the transfer transistor 22.

The circuit block 313 includes an AND circuit 3131 for receiving its two inputs the address signal ADR and a timing signal PTRG3, and an N-channel driving transistor 3132. The circuit block 313 selects the ON voltage Von and supplies the ON voltage Von thus selected to the gate electrode of the transfer transistor 22.

The circuit block 314 includes an AND circuit 3141 for receiving as its two inputs the address signal ADR and an output signal from the NOR circuit 315, an OR circuit 3142 for receiving the address signal ADR at one input terminal having a negative logic set thereat, and receiving an output signal from the AND circuit 3141 at the other input terminal, a level shifter 3143, and an N-channel driving transistor 3144. The circuit block 314 selects the OFF voltage Voff, and supplies the OFF voltage Voff thus selected to the gate electrode of the transfer transistor 22.

In order to supply a voltage lower than the grounding voltage, for example, −1.0 V as the OFF voltage Voff in accordance with which the transfer transistor 22 is turned OFF, the circuit block 314 adopts a circuit configuration for operating exclusively from other circuit blocks 311, 312 and 313 based on the operation of the NOR circuit 315.

FIG. 19 shows a timing relationship between inputs and outputs to and from the supplied-voltage controlling circuit 31. In the case where it is assumed that the voltages to be supplied to the gate electrode of the transfer transistor 22 are the intermediate voltages Vmid0 and Vmid1, the ON voltage Von and the OFF voltage Voff, when the pixel row is selected by the address signal ADR, in accordance with the timing signals PTRG1, PTRG2 and PTRG3, the intermediate voltages Vmid0 and Vmid1, and the ON voltage Von corresponding thereto, respectively, are successively supplied to the gate electrode of the transfer transistor 22, and the OFF voltage Voff is supplied in the case other than the above case.

In the manner as described above, the intermediate voltages Vmid0 and Vmid1, and the ON voltage Von are successively supplied in this order from the supplied-voltage controlling circuit 31 to the gate electrode of the transfer transistor 22 every pixel row synchronously with the vertical scanning operation by the vertical scanning circuit 12 under the control made by the supplied-voltage controlling circuit 31. As a result, it is possible to realize the tri-partition transfer in which the signal charges accumulated in the photoelectric conversion element 21 are transferred to the floating diffusion capacitor 26, for example, in three batches.

### <Tri-Partition Transfer>

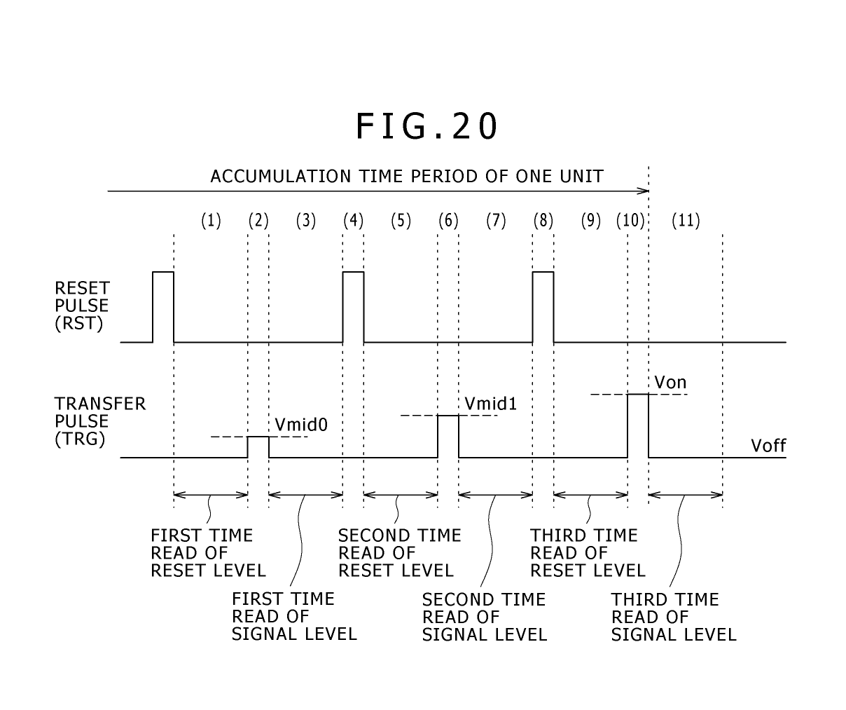

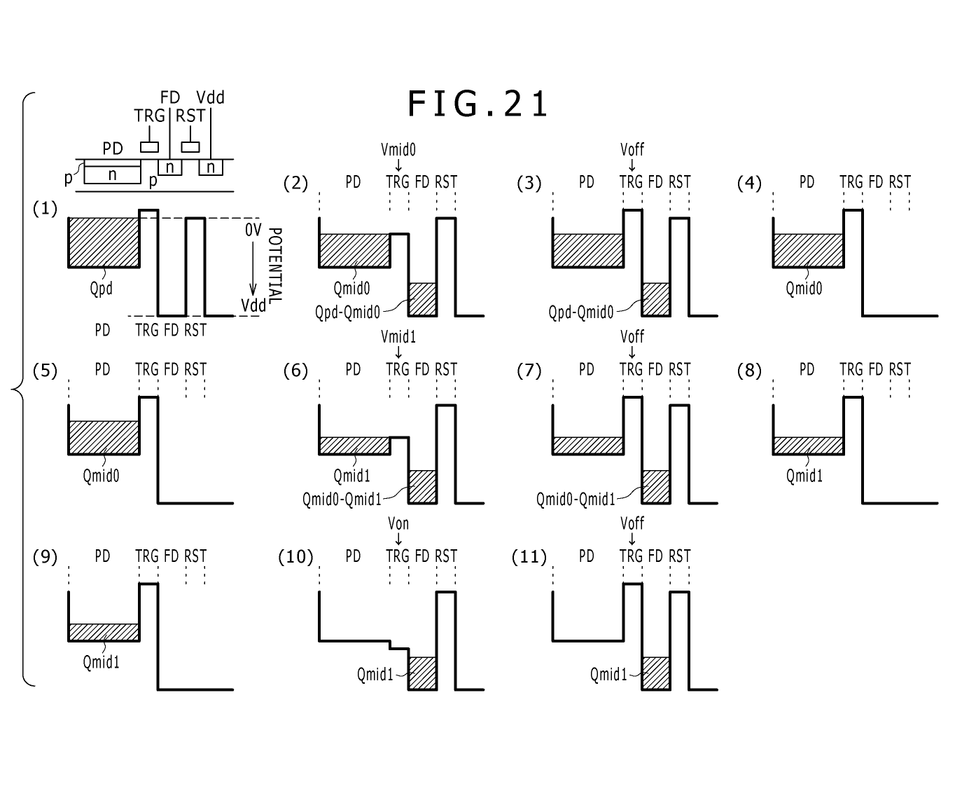

Hereinafter, a concrete operation in the case of the tri-partition transfer in a certain pixel row will be described with reference to a timing chart of FIG. 20, and an operation explanatory diagram of FIG. 21. In FIG. 21, operations (1) to (11) correspond to periods, (1) to (11), of time shown in FIG. 20, respectively.

When the signal charges are transferred on the tri-partition transfer basis for an accumulation period of time of one unit in a certain pixel row, the reset pulse PTS is applied three times at given intervals from the vertical scanning circuit 12 to the gate electrode of the reset transistor 23, thereby carrying out the reset operation for the floating diffusion capacitor 26 three times. The intermediate voltages Vmid0 and Vmid1, and the ON voltage Von are successively supplied in this order from the supplied-voltage controlling circuit 31 to the gate electrode of the transfer transistor 22 when a certain period of time elapses every reset operation synchronously with this reset operations.

For the period (1) of time, the charges Qpd are accumulated in the photoelectric conversion element 21. At this time, the OFF voltage Voff is applied to the gate electrode of the transfer transistor 22. In addition, the floating diffusion capacitor 26 has already been reset by the first time reset pulse RST. A reset level of the floating diffusion capacitor 26 is read out in the form of a first time reset level to the vertical signal line 111 through the amplification transistor 24 and the selection transistor 25.

After completion of the first time reading-out of the reset level, the intermediate voltage Vmin0 is applied to the gate electrode of the transfer transistor 22 for the period (2) of time. The application of the intermediate voltage Vmin0 results in that the charges (Qpd−Qmid0) are transferred to the floating diffusion capacitor 26 with partial charges Qmid0 of the accumulated charges Qpd in the photoelectric conversion element 21 being left as they are.

Next, for the period (3) of time, the OFF voltage is applied to the gate electrode of the transfer transistor 22. As a result, a signal corresponding to the charges (Qpd−Qmid0) transferred to the floating diffusion capacitor 26 is read out in the form of a signal having a first signal level to the vertical signal line 111.

Next, for the period (4) of time, the second time reset pulse RST is applied to the gate electrode of the reset transistor 23, thereby resetting the floating diffusion capacitor 26. Next, for the period (5) of time, a signal having the resulting reset level is read out in the form of a signal having a second time reset level to the vertical signal line 111.

Next, for the period (6) of time, the intermediate voltage Vmid1 is applied to the gate electrode of the transfer transistor 22. The application of the intermediate voltage Vmid1 results in that the charges (Qpd−Qmid1) are transferred to the floating diffusion capacitor 26 with the partial charges Qmid1 of the charges Qmid0 remaining in the photoelectric conversion element 21 being left as they are.

Next, for the period (7) of time, the OFF voltage Voff is applied to the gate electrode of the transfer transistor 22. As a result, a signal corresponding to the charges (Qpd0−Qmid1) transferred to the floating diffusion capacitor 26 is read out in the form of a signal having a second time signal level to the vertical signal line 111.

Next, for the period (8) of time, a third time reset pulse RST is applied to the gate electrode of the reset transistor 23, thereby resetting the floating diffusion capacitor 26. Next, for the period (9) of time, a signal having the resulting reset level is read out in the form of a signal having a third time reset level to the vertical signal line 111.

Next, for the period (10) of time, the ON voltage Von is applied to the gate electrode of the transfer transistor 22. The application of the ON voltage Von results in that the remaining charges Qmid1 in the photoelectric conversion element 21 are transferred to the floating diffusion capacitor 26.

Next, for the period (11) of time, the OFF voltage Voff is applied to the gate electrode of the transfer transistor 22. As a result, a signal corresponding to the charges Qmid1 transferred to the floating diffusion capacitor 26 is read out in the form of a signal having a third time signal level to the vertical signal line 111.

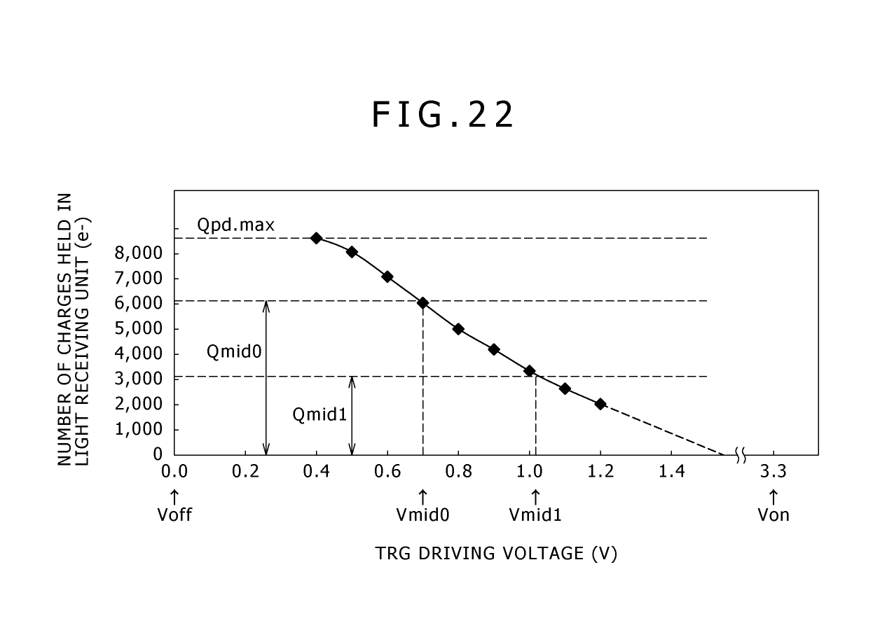

FIG. 22 shows experimental results as an example of a relationship between a TRG driving voltage (a transfer pulse TRG applied to the gate electrode of the transfer transistor 22), and the number of charges held in the photoelectric conversion element 21.

In this case, there is shown in the number of charges held in the photoelectric conversion element 21 when the intermediate voltage Vmid between the ON voltage Von and the OFF voltage Voff in accordance with which the transfer transistor 22 is turned ON and OFF is applied to the photoelectric conversion element 21 having the number of electrons saturated of about 5,500 e⁻.

FIG. 22 also shows the number, Qmid0, of charges held, and the number, Qmid1, of charges held when the driving for the tri-partition transfer is carried out with the intermediate voltage Vmid being set as Vmid0 and Vmin1 as an example. Setting the voltage value of the intermediate voltage Vmid and the number of intermediate voltage Vmid in such a manner results in that the charges accumulated in the photoelectric conversion element 21 can be transferred in arbitrary units of the charges transferred, and the arbitrary number of partitions, and the signals corresponding to the charges thus transferred on the partition basis can be outputted.

In the case of the tri-partition transfer, each of the intermediate voltages Vmid0 and Vmid1 becomes a first control signal, and the ON voltage Von becomes a second control signal.

<n-Partition Transfer>

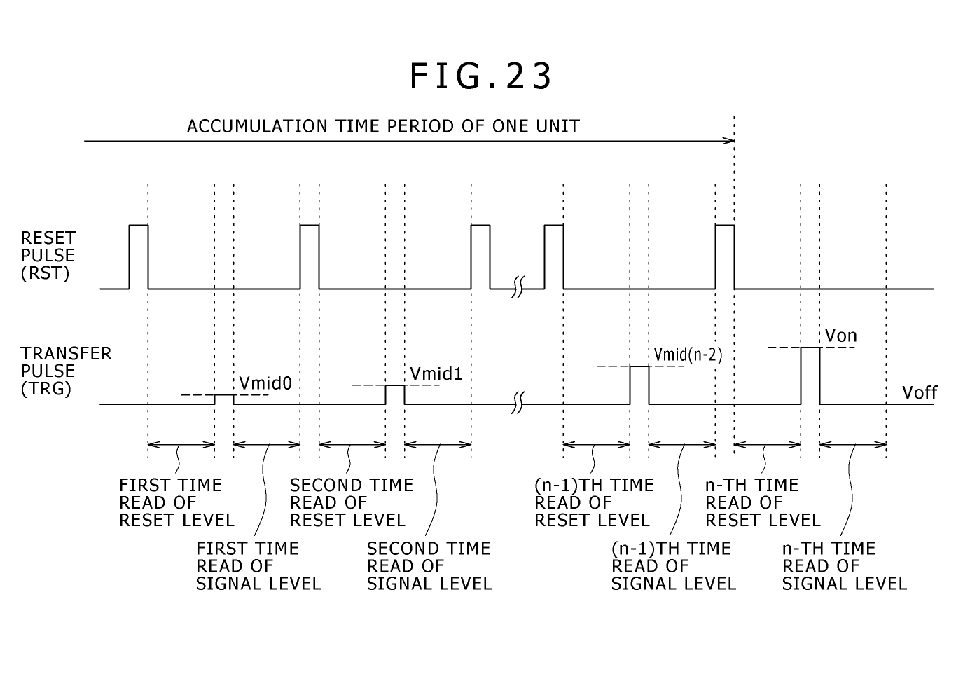

Although in this case, the description has been given so far by giving the case of the tri-partition transfer as an example, the number of partitions for the transfer operation can be arbitrarily set. Also, when n-partition transfer (n: integral number of 2 or more) is carried out, as shown in FIG. 23, the (n−1) intermediate voltages Vmid0, Vmid1, . . . , Vmid(n−2), and the ON voltage Von have to be applied in order from the supplied-voltage controlling circuit 13 to the gate electrode of the transfer transistor 22, thereby driving the transfer transistor 22 concerned.

In the case of the n-partition transfer, each of the (n−1) intermediate voltages Vmid0 to Vmid(n−2) becomes a first control voltage, and the ON voltage Von becomes a second voltage.

The transfer of the charges, the reset, and the pixel selection are carried out every pixel row under the driving based on the n-partition transfer described above. As a result, the signal having the reset level and the signal having the signal level (that is, the output signals from the unit pixel 20) are read out in column-parallel, that is, in parallel in units of pixel columns from the unit pixel 20 to the vertical signal line 111 to be supplied to the column circuit 34 through the vertical signal line 111 concerned.

When the driving method based on the partition basis transfer corresponds to a system for applying the intermediate voltages Vmid0 and Vmid1 in order to the gate electrode of the transfer transistor 22 to transfer the charges in units of the arbitrary quantities of charges on the partition transfer basis, contrary to the case of the driving method based on the partition basis transfer of the first and second embodiments, the charge transfer and output are firstly made in the pixel having a high luminance, while none of the charge transfer and output is firstly made in the pixel having a low luminance.

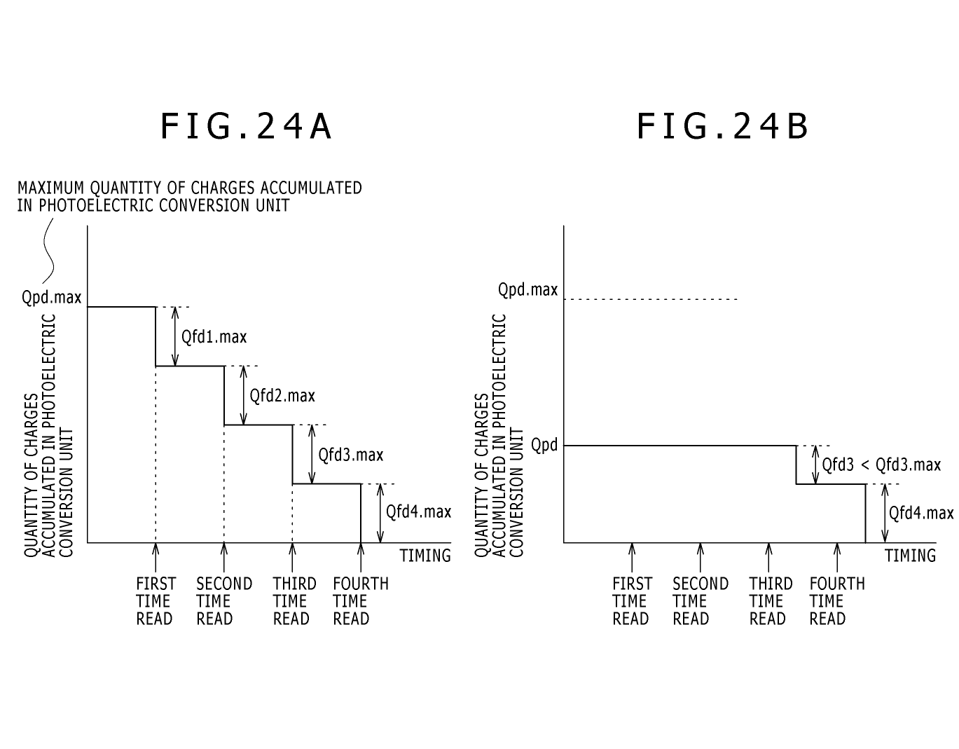

For example, a maximum quantity of charges able to be transferred is determined as shown in FIG. 24A. Also, as shown in FIG. 24B, for example, when the quantity of charges accumulated fulfills a relationship of Qpd>Qfd4·max, and Qpd<Qfd4·max+Qfd3s·max, the accumulated charges having the quantity Qpd are transferred to be outputted in none of the first time reading-out operation and the second time reading-out operation. Also, the charges having the quantity Qfd3 (=Qpd−Qfd4·max) are transferred to be read out in the third time reading-out operation, and the charges having the quantity Qfd4·max are transferred to be read out in the fourth time reading-out operation. Also, addition of the output signals which are outputted in the third time reading-out operation and in the fourth time reading-out operation, respectively, results in all the accumulated charges having the quantity Qpd being obtained.

As described above, in the case of the driving method based on the partition basis transfer shown in FIG. 21, the partition basis transfer is carried out by utilizing the fact that the quantity of charges able to be held in the photoelectric conversion unit (light receiving unit) differs depending on the driving voltage for the transfer transistor 22. For example, in the example shown in FIG. 20, by using each of the intermediate voltages Vmid0 and Vmid1 as the driving voltage for the transfer transistor 22, the charges having the quantity Qmid0 and the charges having the quantity Qmid1 can be held in order in the photoelectric conversion unit, and the quantity of charges exceeding each of the quantity, Qmid0, of charges Qmid0 and the quantity, Qmid1, of charges in order can be successively transferred to be read out.

### (Column Circuit)

The column circuit 17 of the CMOS image sensor 10C of this embodiment can adopt the same configuration as that of the column circuit 17 of the CMOS image sensor 10B of the second embodiment. That is to say, it is possible to adopt the circuit configuration composed of the noise removing unit 171, the A/D conversion unit 172, the signal selecting unit 173, the signal holding unit 174, and the addition unit 175 as shown in FIG. 15. Or, it is possible to adopt the circuit configuration composed of the A/D conversion unit 156 having the noise removing function and the addition function as shown in FIG. 16.

In order to solve the problem described above in the case where the A/D conversion is carried out with the same conversion precision, the feature of the column circuit 17 having the above configuration is that the A/D conversion is carried out with the different conversion precisions in each of the A/D conversion units 172 and 176 for the output signals read out on the partition transfer basis similarly to the case of each of the first and second embodiments.

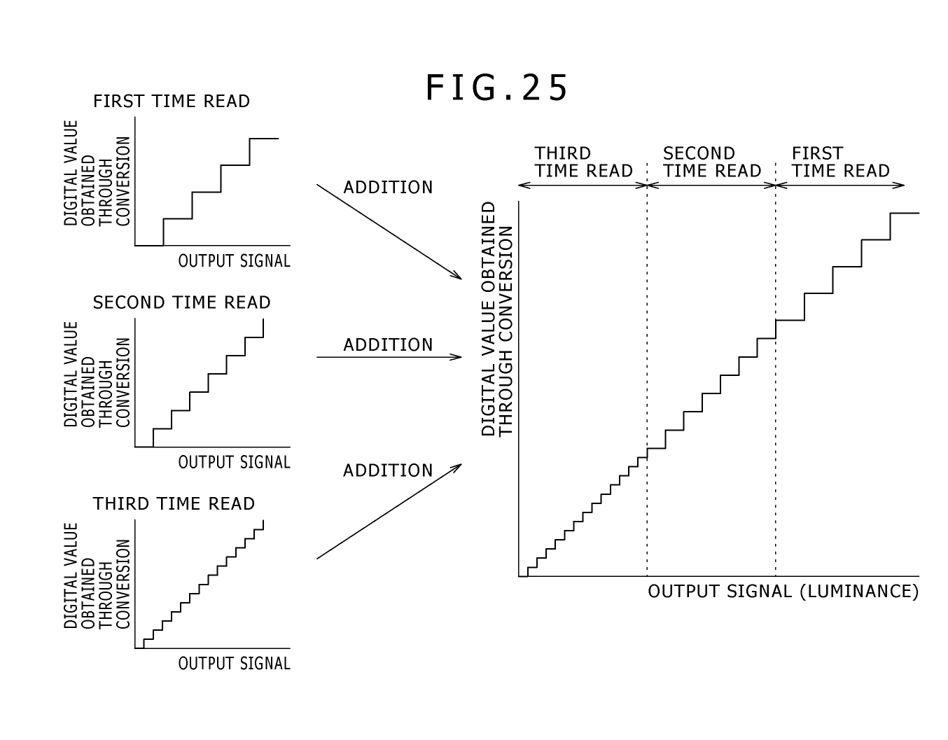

FIG. 25 is a diagram explaining processing when the A/D conversion is carried out with the different conversion precisions during the tri-partition transfer. This processing is an example in which the A/D conversion is carried out with the relatively low conversion precision in the first time reading-out operation, and also the conversion precision is successively increased for the second time and third time reading-out operations. In such a manner, the output signals for n reading-out operations based on the partition transfer basis are subjected to the A/D conversion with the different conversion precisions to be added to one another, thereby making it possible to obtain the A/D conversion characteristics with which the conversion precision is changed over to another one in correspondence to the luminance of the incident light.

This reason for this is that since the number of charges accumulated in the photoelectric conversion element 21 is less when the luminance of the incident light is low, the charges are transferred only in the case of such a luminance as to generate the charges having the quantity exceeding the threshold depending on the intermediate voltages Vmid0 and Vmid1.

In the case where the charges are transferred on the tri-partition basis as with the example shown in FIG. 22, when the accumulated charges the number of which is smaller than the number, Qmid1, of charges held are generated, that is, when the luminance of the incident light is low, the output signal is obtained only in the third time transferring operation. On the other hand, when there are the accumulated charges the number of which exceeds the number, Qmid0, of charges held, that is, when the luminance of the incident light is high, the output signals are obtained since the charges are transferred from the first time transferring operation on.

As a result, as shown in FIG. 25, it is possible to obtain the characteristics with which when the luminance is low, the high A/D conversion precision is applied, while when the luminance is high, the A/D conversion precisions which are successively mixed with the low A/D conversion precisions are applied.

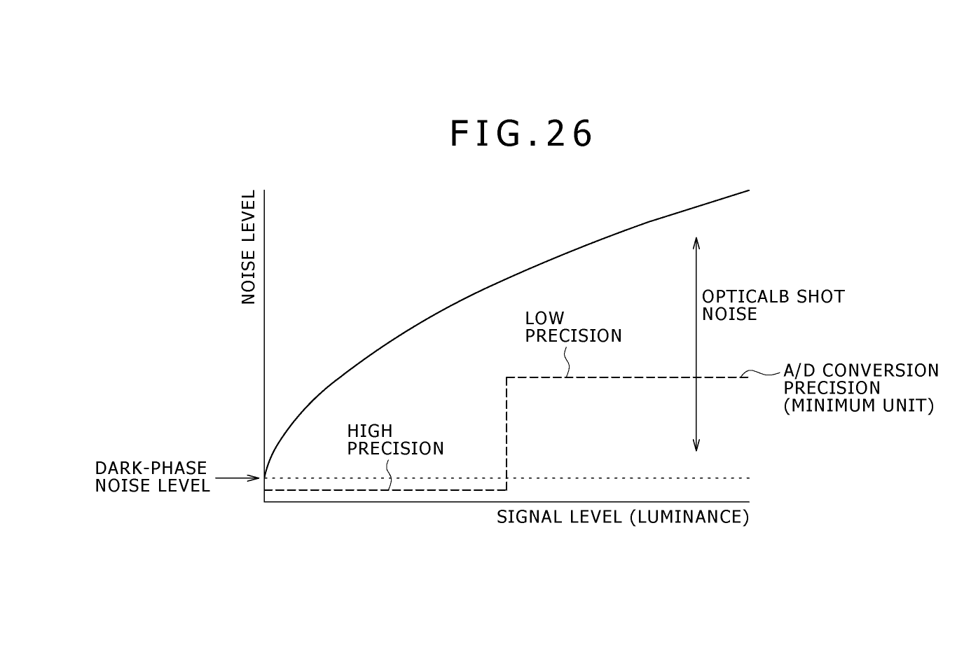

Here, the noise level of the output signal is roughly classified into a dark-phase noise which is generated in the circuit or the like when there is no luminance of the incident light, and an optical shot noise which is generated by the energy obtained in the form of the square root of the luminance of the incident light depending on the luminance of the incident light. For this reason, as shown in FIG. 26, the noise level has the characteristics in which the optical shot noise having the characteristics of the square root of the signal level is added to the dark-phase noise for the signal level proportional to the luminance of the incident light.

Since the A/D conversion precision, that is, a minimum detection unit in the A/D conversion is preferably lower than the noise level, the A/D conversion needs to be carried out with the high precision in the case of the low luminance. However, in the case of the high luminance, the optical shot noise is dominant. Thus, even when the A/D conversion is carried out with the low precision for the output signal to increase the quantization error in the A/D conversion, the image quality is hardly impaired.

### <Concrete Example for Setting Different A/D Conversion Precisions>

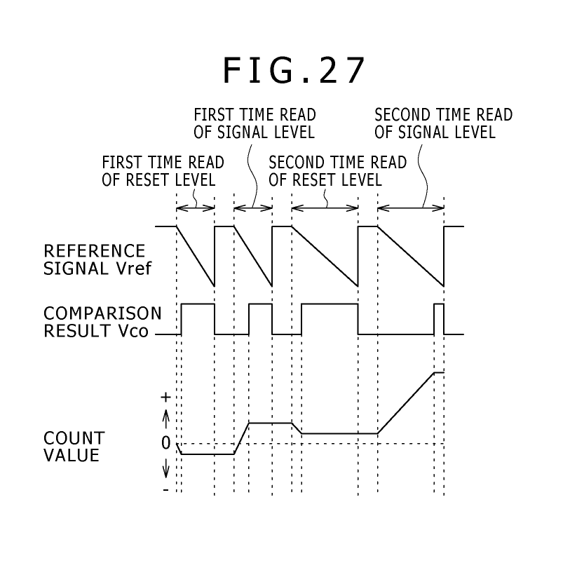

Subsequently, a description will now be given with respect to a concrete example for setting the different A/D conversion precisions with the configuration of the A/D conversion unit 156 shown in FIG. 10 with reference to FIG. 27.

The ramp of the reference signal Vref is caused to be N-fold, thereby making it possible to roughen the voltage value per one count, that is, the minimum detection quantity in the A/D conversion. For example, as shown in FIG. 27, in the first time reading-out operation, the ramp of the reference signal Vref is made double that of the reference signal Vref in the second time reading-out operation, thereby applying the A/D conversion having the low conversion precision set therein to the first time reading-out operation.

On the other hand, when the output signals transferred on the tri-partition transfer are added to one another, the count value is incremented by N in one clock of the clock CK synchronously with which the counter 1562 is operated, which results in that the output signals transferred on the partition transfer basis can be added to one another with the same weighting factor.

For example, when the ramp of the reference signal Vref is doubled as shown in FIG. 27, the count value is incremented or decremented by 2 per one clock, which results in that the addition with the same weighting factor is carried out while the conversion precision is reduced.

In addition, the ramp of the reference signal Vref is charged without daring to cause the count value to be N-fold, or the count value is caused to be N-fold without changing the ramp of the reference signal Vref, which results in that the output signals transferred on the partition transfer basis can also be added to one another while being multiplied by arbitrary weighting factors, respectively.

(Effect of this Embodiment)

As has been described so far, in the CMOS image sensor 10C which performs the charge transfer and the signal output on the partition basis when all the accumulated charges in the photoelectric conversion element 21 can not be read out in one reading-out operation, the output signals outputted from the unit pixel 20 on the n-partition transfer are subjected to the A/D conversion with the different conversion precisions to be added to one another. As a result, the execution time (conversion speed) for the A/D conversion can be shortened and the power consumed in each of the A/D conversion units 152 and 156 can be reduced without impairing the image quality.

More specifically, in the CMOS image sensor 10C of this embodiment, as previously described with reference to FIGS. 20 to 22, using the driving method based on the partition transfer with the intermediate voltages Vmid0 and Vmid1 results in that the accumulated charges generated in the case of the high luminance are transferred and outputted in the preceding reading-out operation, and the accumulated charges generated in the case of the low luminance are transferred and outputted only in the subsequent reading-out operation. For this reason, as exemplified in FIG. 27, the application of the A/D conversion having the lower conversion precision set therein to the signal outputted in the preceding reading-out operation realizes the speed-up of the A/D conversion and the reduction of the power consumption.

### [High Conversion Efficiency]

In each of the CMOS image sensors 10A to 10C of the first to third embodiments described above, in order to enhance the charge-to-voltage conversion efficiency in the floating diffusion capacitor 26, the parasitic capacitance (FD capacitance) parasitic on the floating diffusion capacitor (charge-to-voltage conversion unit) 26 to which the signal charges are transferred from the photoelectric conversion element 21 is made minute, specifically, the parasitic capacitance is reduced so that the maximum quantity of charges treated by the floating diffusion capacitor 26 becomes smaller than the maximum quantity of charges able to be accumulated in the photoelectric conversion element 21, thereby making it possible to obtain the higher charge-to-voltage conversion efficiency.

That is to say, in the CMOS image sensors 10A to 10C in each of which the charge-to-voltage conversion efficiency is enhanced by, for example, reducing the parasitic capacitance parasitic on the floating diffusion capacitor 26 to relatively reduce the random noises and the fixed pattern noises against the signal levels of the output signals and to improve the charge-to-voltage conversion efficiency, thereby transferring the accumulated charges, unable to be read out in one reading-out operation, on the partition transfer basis, the A/D conversion having the high conversion precision set therein is applied to the low luminance region, while the A/D conversion having the low conversion precision set therein, although having the high speed in its processing, is applied to the high luminance region in which the optical shot noise is the dominant noise component. As a result, the speed-up of the A/D conversion, and the reduction of the power consumption can be realized without impairing the image quality.

### [Modifications]

In addition, although in each of the first to third embodiments, the description has been given so far by giving, as an example, the case where the present invention is applied to the CMOS image sensor including the unit pixel 20 having the configuration that the charges in the photoelectric conversion element 21 are transferred to the common floating diffusion capacitor 26 on the partition transfer basis by one transfer transistor 22, and are successively read out to the common vertical signal line 111, the present invention is by no means limited thereto, and various changes can be made.

### (Modification 1)

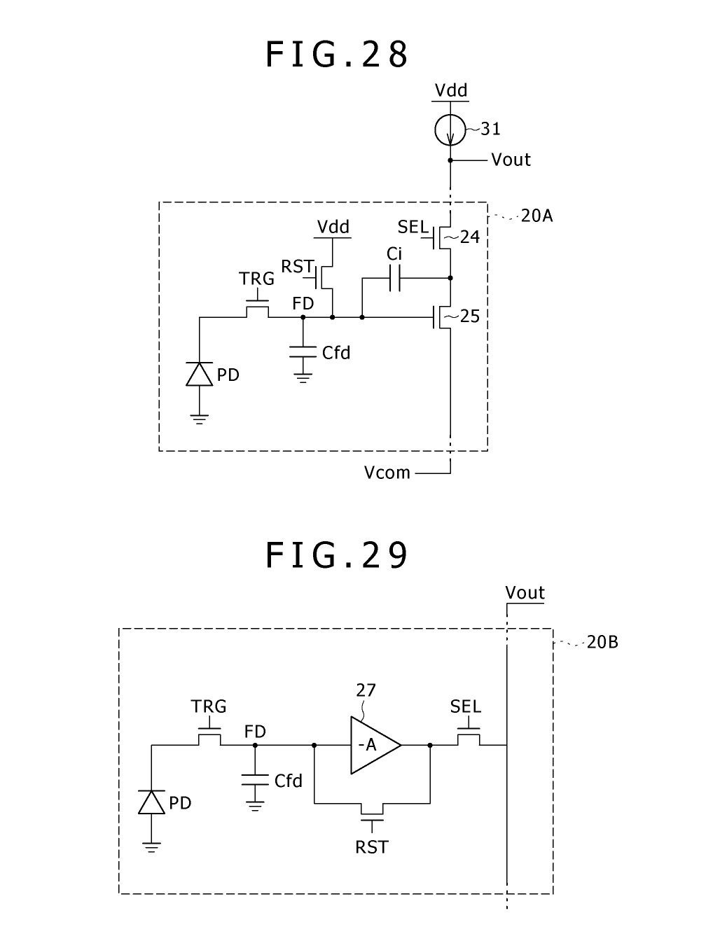

FIG. 28 is a circuit diagram showing a pixel circuit of a unit pixel 20A of Modification 1. In the figure, units equal to those previously described with reference to FIG. 2 are designated by the same reference numerals, respectively.

As shown in FIG. 28, the unit pixel 20A of Modification 1 is configured such that a current source 31 is connected between the drain electrode of the selection transistor 25 connected in series with the amplification transistor 24, and the power source, and the output signal Vout is derived from the drain node of the selection transistor 25.

In the unit pixel 20A, the charge-to-voltage conversion efficiency in the floating diffusion capacitor 26 depends on the capacitance value Ci of the parasitic capacitance between the floating diffusion capacitor 26 and the vertical signal line 111. Thus, the capacitance value Ci of the parasitic capacitance is made smaller than the capacitance value Cfd of the floating diffusion capacitor 26, thereby making it possible to enhance the charge-to-voltage conversion efficiency.

Here, obtaining the effect of the high charge-to-voltage conversion efficiency is conditional on a relationship of Qi·max<Qfd·max where Qfd·max is the maximum quantity of charges accumulated in the floating diffusion capacitor 26, and Qi·max is the maximum quantity of charges accumulated in the parasitic capacitance Ci. For this reason, the charges, having the quantity Qpd, accumulated in the photoelectric conversion element 21 must be transferred on the partition transfer basis with the maximum quantity, Qi·max, of charges accumulated less than the maximum quantity, Qfd·max, of charges accumulated as a unit.

As has been described so far, the CMOS image sensor including the unit pixel 20A having the high charge-to-voltage conversion efficiency or the high voltage amplification factor is advantageous in the S/N ratio, while there may be a limit to the quantity of charges able to be read out in one reading-out operation.

The partition transfer previously described is applied to the CMOS image sensor including the unit pixel 20A, so that the charges in the photoelectric conversion element 21 are transferred on the partition transfer basis, which results in that all the charges generated in the photoelectric conversion element 21 can be efficiently outputted depending on the output range of the reading-out circuit.

In addition, in the unit pixel 20A of Modification 1 shown in FIG. 28, the voltage of the charge-to-voltage conversion unit (the floating diffusion capacitor 26) in the phase of the reset must be set at an operating point of the reading-out circuit. However, application of the partition basis transfer previously stated makes it possible to control the quantity of charges transferred on the partition transfer basis without depending on the potential of the charge-to-voltage conversion unit.

### (Modification 2)

FIG. 29 is a circuit diagram showing a pixel circuit of a unit pixel 20B of Modification 2. In the figure, units equal to those previously described with reference to FIG. 2 are designated by the same reference numerals, respectively.

As shown in FIG. 29, the unit pixel 20B of Modification 2 is configured such that an inverting amplification circuit 27 is connected between the floating diffusion capacitor 26 and the selection transistor 25 instead of using the amplification transistor 24, and the reset transistor 23 is connected in parallel with the inverting amplification circuit 27. Providing the inverting amplification circuit 27 inside the pixel in such a manner results in that the signal level can be amplified to improve the S/N ratio.

In the CMOS image sensor including the unit pixel 20C having the inverting amplification circuit 27 provided inside the pixel in such a manner, when an amplification factor of the inverting amplification circuit 27 is set as −A, an amplitude, −A·Qfd·max/Cfd, of the output voltage Vout when the accumulated charges, having the maximum quantity, Qfd·max, are transferred to the floating diffusion capacitor 26 exceed an outputable range ΔVout·pp of the output Vout in some cases.

In this case, in order to output all the charges in the form of the output signals, the partition basis transfer must be carried out in units of the quantity of charges in which a quantity, Qmid (<Qfd·max), of charges less than the maximum quantity, Qfd·max, of charges accumulated in the floating diffusion capacitor 26 is set as being maximum.

The partition basis transfer previously stated is applied to the CMOS image sensor including the unit pixel 20B, and the charges in the photoelectric conversion element 21 are transferred on the arbitrary partition transfer basis, which results in that all the charges generated in the photoelectric conversion element 21 can be efficiently outputted in correspondence to the outputable range ΔVout·pp of the output voltage Vout.

Note that, in each of the first to third embodiments described above, the description has been given so far by giving, as an example, the case where the present invention is applied to the CMOS image sensor in which the unit pixels each serving to detect the signal charges corresponding to a quantity of visible light in the form of a physical quantity are arranged in matrix. However, the present invention is by no means limited to the application to the CMOS image sensor. That is to say, the present invention can also be applied to the general solid-state imaging devices each using the column system in which the column circuit is arranged every pixel column of the pixel array unit.

In addition, the present invention is by no means limited to the application to the imaging device for detecting a distribution of a quantity of incident visible light to capture the distribution thereof in the form of an image. That is to say, the present invention can also be applied to all the solid-state imaging device for detecting a distribution of a quantity of incident infrared rays, X-rays, particles or the like to capture the distribution thereof in the form of an image, and the solid-state imaging device (physical quantity distribution detecting device), such as a fingerprint detecting sensor, for detecting a distribution of other physical quantity such as a pressure or an electrostatic capacitance in a broad sense to capture the distribution thereof in the form of an image.

Moreover, the present invention is by no means limited to the solid-state imaging device for reading out the pixel signals from the respective unit pixels by successively scanning the unit pixels of the pixel array unit in units of rows. That is to say, the present invention can also be applied to an X-Y address type solid-state imaging device for selecting arbitrary pixels in units of pixels, and reading out the signals from the respective pixels thus selected in units of pixels.

It is noted that the solid-state imaging device may have a form of being formed as one chip, or may have a module form, having an imaging function, in which an imaging unit, and a signal processing unit or an optical system are collectively packed.

In addition, the present invention can be applied not only to the solid-state imaging device, but also to an imaging apparatus. Here, the imaging apparatus means a camera system such as a digital still camera or a video camera, or an electronic apparatus, having an imaging function, such as a mobile phone. It is noted that the imaging apparatus also means the above module form mounted to the electronic apparatus, that is, a camera module in some cases.

### [Imaging Apparatus]

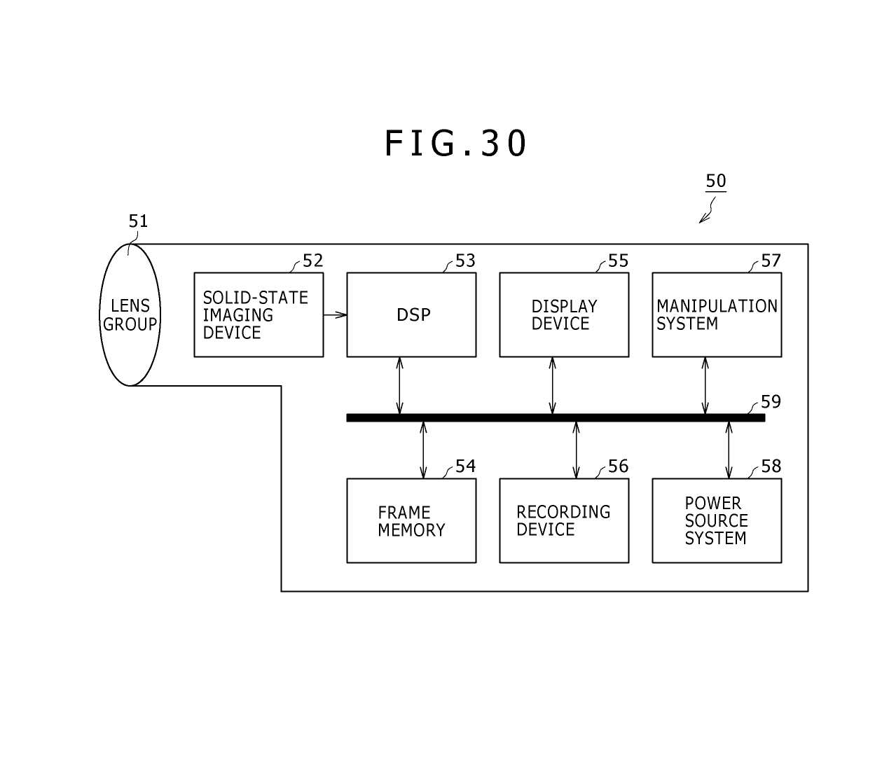

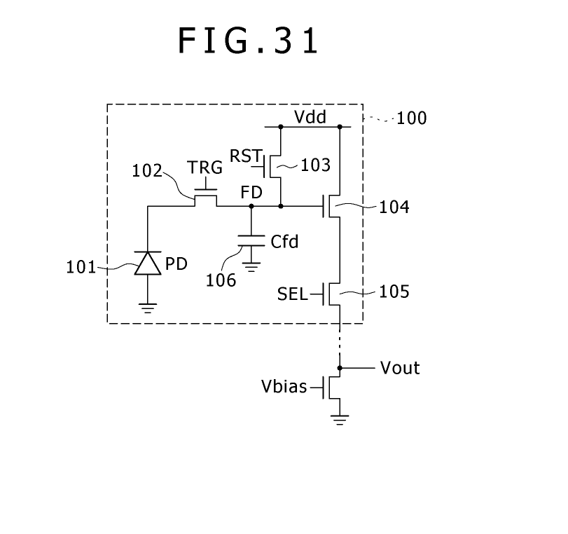

FIG. 30 is a block diagram showing a configuration of an imaging apparatus according to an embodiment of the present invention. As shown in FIG. 30, the imaging apparatus 50 according to the embodiment of the present invention includes an optical system having a lens group 51, a solid-state imaging device 52, a DSP circuit 53 as a camera signal processing circuit, a frame memory 54, a display device 55, a recording device 56, a manipulation system 57, a power source system 58, and the like. Also, the DSP circuit 53, the frame memory 54, the display device 55, the recording device 56, the manipulation system 57, and the power source system 58 are connected to one another through a bus line 59.

The lens group 51 captures an incident light (image light) from a subject to focus the incident light onto an imaging area of the solid-state imaging device 52. The solid-state imaging device 52 converts a quantity of incident light focused onto the imaging area by the lens group 51 into electrical signals in units of pixels and outputs the electrical signals in the form of pixel signals. The CMOS image sensor 10 of each of the first to third embodiments described above is used as the solid-state imaging device 52.

The display device 55 is constituted by a panel type display device such as a liquid crystal display device or an organic electro luminescence (EL) display device. The display device 55 displays thereon a moving image or a still image captured by the solid-state imaging device 52. The recording device 56 records image data on the moving image or the still image captured by the solid-state imaging device 52 in a recording medium such as a video tape or a digital versatile disk (DVD).

The manipulation system 57 issues manipulation commands about the various functions which the imaging apparatus of this embodiment has under the manipulation made by a user. The power source system 58 suitably supplies the various power sources becoming the operation power sources for the DSP circuit 53, the frame memory 54, the display device 55, the recording device 56, and the manipulation system 57 to those objects of power supply, respectively.

As has been described so far, in the imaging apparatus, such as the camera module, for the video camera or the digital still camera, or the mobile apparatus such as the mobile phone, any one of the CMOS image sensors 10A to 10C of the first to third embodiments described above is used as the solid-state imaging device 52 thereof, which results in that the A/D conversion can be speeded up and the power consumption in the A/D conversion unit can be reduced without impairing the image quality. Consequently, the increasing of the processing speed and the reduction of the power consumption can be realized for the imaging apparatus.

It should be understood by those skilled in the art that various modifications, combinations, sub-combinations and alterations may occur depending on design requirements and other factors insofar as they are within the scope of the appended claims or the equivalents thereof.

What is claimed is:

1. A solid-state imaging device, comprising:
a pixel array unit constituted by arranging unit pixels in matrix, each of said unit pixels including a photoelectric conversion unit configured to convert an optical signal into signal charges, a transfer element configured to transfer the signal charges obtained through photoelectric conversion in said photoelectric conversion unit, and output means configured to output the signal charges transferred by said transfer element;
driving means configured to read out the signal charges accumulated in said photoelectric conversion unit for an accumulation period of time of one unit and transferred at least in two batches by said transfer element through said output section; and
analog-to-digital conversion means configured to perform analog-to-digital conversion for a plurality of output signals read out from said unit pixel in plural batches with different conversion precisions.

2. The solid-state imaging device according to claim 1, further comprising:
addition means configured to execute addition processing for the plurality of output signals read out from said unit pixel in plural batches.

3. The solid-state imaging device according to claim 1, wherein said output means includes a charge-to-voltage conversion unit configured to convert the signal charges transferred by said transfer element into a voltage, and a parasitic capacitance is set as being small so that a maximum quantity of charges treated by said charge-to-voltage conversion unit is less than a maximum quantity of charges accumulable in said photoelectric conversion unit.

4. The solid-state imaging device according to claim 1, wherein while a part of the signal charges accumulated in said photoelectric conversion unit is held in said photoelectric conversion unit, said driving means gives a control voltage in accordance with which the accumulated charges having a quantity exceeding a quantity of charged held are transferred by said transfer element to said transfer element at least once.

5. The solid-state imaging device according to claim 1, wherein in a case where an intensity of an incident light is relatively low, said analog-to-digital conversion means performs the analog-to-digital conversion with a higher conversion precision for the output signals outputted from said unit pixel when the charge transfer by said transfer element is caused than for the output signals outputted from said unit pixel when no charge transfer by said transfer element is caused.

6. The solid-state imaging device according to claim 1, wherein said analog-to-digital conversion means includes:
comparing means configured to compare each of the plurality of signals with a reference signal; and
counting means configured to carry out an operation for performing counting by a count value corresponding to a comparison result obtained from said comparing means.

7. The solid-state imaging device according to claim 6, wherein said analog-to-digital conversion means causes a ramp of the reference signal to be N-fold, and causes a count value of said counting means to be N-fold, thereby causing the conversion precision to be 1/N-fold.

8. The solid-state imaging device according to claim 6, wherein said counting means carries out up-count or down-count by the count value corresponding to the comparison result obtained from said comparing means.

9. The solid-state imaging device according to claim 8, wherein said analog-to-digital conversion means obtains a difference between a reset level and the signal level obtained from said unit pixel in accordance with the up-count or the down-count by said counting means.

10. The solid-state imaging device according to claim 6, wherein said analog-to-digital conversion means executes addition processing for the plurality of output signals read out from said unit pixel in plural batches in accordance with a counting operation by said counting means concurrently with the analog-to-digital conversion processing.

11. A signal processing method for a solid-state imaging device comprising:
a pixel array unit constituted by arranging unit pixels in matrix, each of said unit pixels including a photoelectric conversion unit configured to convert an optical signal into signal charges, a transfer element configured to transfer the signal charges obtained through photoelectric conversion in said photoelectric conversion unit, and an output section configured to output the signal charges transferred by said transfer element; and
driving means configured to read out the signal charges accumulated in said photoelectric conversion unit for an accumulation period of time of one unit and transferred at least in two batches by said transfer element through said output section;
wherein said solid-state imaging device performs analog-to-digital conversion for a plurality of output signals read out from said unit pixel in plural batches with different conversion precisions.

12. The solid-state imaging device according to claim 11, wherein in a case where an intensity of an incident light is relatively low, the analog-to-digital conversion is performed with a higher conversion precision for the output signals outputted from said unit pixel when the charge transfer by said transfer element is caused than for the output signals outputted from said unit pixel when no charge transfer by said transfer element is caused.

13. An imaging apparatus, comprising:
a solid-state imaging device constituted by arranging unit pixels in matrix, each of said unit pixels including a photoelectric conversion unit configured to convert an optical signal into signal charges, a transfer element configured to transfer the signal charges obtained through photoelectric conversion in said photoelectric conversion unit, and output means configured to output the signal charges transferred by said transfer element; and
an optical system for focusing an incident light onto an imaging area of said solid-state imaging device;
wherein the solid-state imaging device comprises:
driving means configured to read out the signal charges accumulated in said photoelectric conversion unit for an accumulation period of time of one unit and transferred at least in two batches by said transfer element through said output means; and
analog-to-digital conversion means configured to perform analog-to-digital conversion for a plurality of output signals read out from said unit pixel in plural batches with different conversion precisions.
